(19) United States
(12) Patent Application Publication
(10) Pub. No.: US 2026/0193385 A1
(43) Pub. Date: Jul. 9, 2026

(54) PREPARATION OF MEDIUM MOLECULAR WEIGHT HEPARIN

(71) Applicant: GLYCOS BIOMEDICAL LTD, London (GB)

(72) Inventors: Pervinder Singh BHOGAL, London (GB); John BRACKETT, Ponca City, OK (US); Graham RUSHTON, London (GB)

(73) Assignee: GLYCOS BIOMEDICAL LTD, London (GB)

(21) Appl. No.: 19/130,744

(22) PCT Filed: Nov. 17, 2023
(86) PCT No.: PCT/EP2023/082300

§ 371 Date: May 16, 2025

(30) Foreign Application Priority Data
Nov. 17, 2022 (GB) 2217216.7

(51) Int. Cl. C08B 37/00

(52) U.S. Cl. CPC C08B 37/0078

(57) ABSTRACT

A method of synthesis of medium molecular weight heparin includes the steps of dissolving unfractionated heparin in an aqueous buffer solution adjusted to between about pH 5.0 and about pH 9.0 to provide a first solution; adding an oxidising agent to the first solution to provide a second solution; and incubating the second solution at a temperature of from about 0° C. to about 10° C. to form a medium molecular weight heparin solution.

### FIELD OF THE INVENTION

The present invention relates to the synthesis of medium molecular weight heparins, preferably via low temperature periodate oxidation.

### BACKGROUND OF THE INVENTION

Heparin is a naturally occurring, highly sulphated polysaccharide characterised by a wide molecular weight range of polysaccharide chains. Heparin acts at a variety of different ligands with varied actions. Heparin is a member of the glycosaminoglycan carbohydrate family and consists of repeating disaccharide units of GlcAβ1-4GlcNAcα1-4 with poly-disperse sulfation, N-acetylation and uronosyl epimerization. Heparin is highly heterogenous. Heparin isolated from natural sources contains polysaccharide chains with molecular weights ranging from about 3000 Da (g/mol) to about 30,000 Da (g/mol). This is known as unfractionated heparin (UFH or UF heparin). UFH can be enzymatically or chemically treated to deliver shorter polysaccharide chains. Heparinase I cleaves at the α-1,4 linkage between nonacetylated GlcNS6S and IdoA2S. The products of the chemically or enzymatically treated UFH can be affinity purified to yield fractionated heparin where the molecular weight of the polysaccharides in each fraction can be readily determined. Low molecular weight heparin (LMWH) contains polysaccharide chains in the range of about 4000 Da (g/mol) to about 8000 Da (g/mol).

There are few known methods of preparing medium molecular weight heparin. One example of a method of preparing medium molecular weight heparin is described in Poletti L F, Bird K E, Marques D, Harris R B, Suda Y, Sobel M. Structural aspects of heparin responsible for interactions with von Willebrand factor. Arterioscler Thromb Vasc Biol. 1997 May; 17 (5): 925-31. This method requires incubation at 37° C. and produces a wide variety of products ranging in molecular weight from 10600 g/mol down to 1900 g/mol.

Accordingly, there is a need for a reliable method of preparing medium molecular weight heparin.

### SUMMARY OF THE INVENTION

In a first aspect, the invention provides a method of synthesis of medium molecular weight heparin, the method comprising the steps of: (a) dissolving unfractionated heparin in an aqueous buffer solution adjusted to between about pH 5.0 and about pH 9.0 to provide a first solution; (b) adding an oxidising agent to the first solution to provide a second solution; and (c) incubating the second solution at a temperature of from about 0° C. to about 10° C. to form a medium molecular weight heparin solution.

In a second aspect, the invention provides a kit suitable for preparing medium molecular weight heparin, wherein the kit comprises: (a) unfractionated heparin; (b) an aqueous buffer solution adjusted to between about pH 5.0 and about pH 9.0; (c) an oxidising agent; and (d) optionally, an inactivating agent.

In a third aspect, the invention provides a method of preparing reduced medium molecular weight heparin (MMWH-Red) comprising (a) dissolving unfractionated (UF) heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; and (d) incubating the medium molecular weight heparin with a reducing agent to produce MMWH-Red.

In a fourth aspect, the invention provides reduced medium molecular weight heparin (MMWH-Red). Preferably, MMWH-Red is prepared according to the first or third aspect of the invention.

In a fifth aspect, the invention provides the invention provides reduced medium molecular weight heparin produced according to the following steps: (a) dissolving unfractionated (UF) heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; and (d) incubating the medium molecular weight heparin with a reducing agent to produce reduced medium molecular weight heparin.

In a sixth aspect, the invention provides a composition comprising reduced medium molecular weight heparin.

In a seventh aspect the invention provides reduced medium molecular weight heparin according to the fourth or fifth aspect of the invention or a composition according to the sixth aspect of the invention for use in the treatment of endotheliopathy.

In an eighth aspect, the invention provides reduced medium molecular weight heparin for use in the treatment of a disease or condition in a patient, wherein the patient has an endotheliopathy characterised by a plasma von Willebrand factor to ADAMTS13 (VWF:ADAMTS13) ratio of at least about 2.

In a ninth aspect, the invention provides reduced medium molecular weight heparin for use in the treatment of a disease or condition in a patient, wherein the patient has an endotheliopathy characterised by a plasma von Willebrand factor antigen to ADAMTS13 (VWF antigen:ADAMTS13) ratio of at least about 2.

In a tenth aspect, the invention provides a method of treating endotheliopathy, the method comprising administering to a subject in need of treatment a therapeutically effective amount of reduced medium molecular weight heparin. Preferably, wherein the patient has plasma VWF:ADAMTS13 ratio of at least about 2.

In an eleventh aspect, the invention provides the use of the reduced medium molecular weight heparin for the manufacture of a medicament for the treatment of endotheliopathy in a patient. Preferably, wherein the patient has plasma VWF:ADAMTS13 ratio of at least about 2.

In an twelfth aspect, the invention provides the use of the reduced medium molecular weight heparin for the manufacture of a medicament for the treatment of endotheliopathy in a patient. Preferably, wherein the patient has plasma VWF antigen:ADAMTS13 ratio of at least about 2.

For the avoidance of doubt, embodiments related to each aspect of the invention apply mutatis mutandis to the other aspects of the invention. Further aspects and embodiments of the present invention will be evident from the discussion that follows below.

### BRIEF DESCRIPTION OF THE DRAWINGS

FIG. 1 shows MMWH prepared at 4° C. compared to heparin treated at 37° C., untreated heparin and a 11 kDa standard.

FIG. 2 shows MMWH prepared at 4° C. using only periodate compared to heparin treated with periodate then NaOH at 4° C.

FIG. 3 Graph of molecular weight spread of prepared medium molecular weight heparin.

FIG. 4 Graph of activity of Low Molecular Weight (LMW) heparin, Unfractionated (UF) heparin and Medium Molecular Weight (MMW) heparin against Factor IIa.

FIG. 5 Graph of activity of LMW heparin, UF heparin and MMW heparin against Factor X.

### DETAILED DESCRIPTION OF THE INVENTION

Throughout this specification, one or more aspects of the invention may be combined with one or more features described in the specification to define distinct embodiments of the invention.

In the discussion that follows, reference is made to a number of terms, which are to be understood to have the meanings provided below, unless a context expressly indicates to the contrary.

References herein to a singular of a noun encompass the plural of the noun, and vice-versa, unless the context implies otherwise.

Throughout this specification the word “comprise”, or variations such as “comprises” or “comprising”, will be understood to imply the inclusion of a stated element or integer, or group of elements or integers, but not the exclusion of any other element or integer, or group of elements or integers. The term “comprising” includes within its ambit the term “consisting” or “consisting essentially of”.

The term “consisting” or variants thereof is to be understood to imply the inclusion of a stated element or integer, or group of elements or integers, and the exclusion of any other element or integer or group of elements or integers.

The term “consisting essentially of” or variants thereof is to be understood to imply the inclusion of a stated element, integer or step, or group of elements, integers or steps, and that further components may be present, but only those not materially affecting the essential characteristics of the formulation, composition, or compound.

The term “about” herein, when qualifying a number or value, is used to refer to values that lie within ±5% of the value specified.

The terms “treatment” and “therapy” define the therapeutic treatment of a patient, in order to reduce or halt the rate of progression of a disorder or condition, or to ameliorate or cure the disorder or condition. Prophylaxis of a disorder or condition as a result of treatment or therapy is also included.

As used herein, the term “patient” preferably refers to a mammal. Typically, the mammal is a human.

von Willebrand factor (VWF) is a blood glycoprotein involved in haemostasis. VWF is a large multimeric glycoprotein present in blood plasma and produced constitutively as ultra-large VWF in endothelium (in the Weibel-Palade bodies), megakaryocytes (α-granules of platelets), and subendothelial connective tissue. The basic VWF monomer is a 2050-amino acid protein.

A disaccharide is a sugar whose molecules contain two monosaccharide residues.

A low molecular weight heparin is defined herein as a heparin with an average molecular weight of from about 4000 Da (g/mol) to about 8000 Da (g/mol). A medium molecular weight heparin is defined herein as a heparin with an average molecular weight of from greater than about 8000 Da (g/mol) to about 13000 Da (g/mol).

Accordingly, in a first aspect, the invention provides a method of synthesis (or preparation) of medium molecular weight heparin (MMWH).

The medium molecular weight heparin prepared by the method of the first aspect of the invention may have a mass in the range of greater than about 8000 Da (g/mol) to about 13 000 Da (g/mol), preferably about 10 000 Da (g/mol) to about 12 000 Da (g/mol). The medium molecular weight heparin prepared by the method of the first aspect of the invention may have a mass of about 11 000 Da (g/mol).

The medium molecular weight heparin prepared by the method of the first aspect of the invention may comprise polysaccharide chains with an average molecular mass in the range of about 8000 Da (g/mol) to about 13 000 Da (g/mol), preferably about 10 000 Da (g/mol) to about 12 000 Da (g/mol). The medium molecular weight heparin prepared by the method of the first aspect of the invention may comprise polysaccharide chains with an average molecular mass of about 11 000 Da (g/mol).

The molecular weight of the medium molecular weight heparin prepared by the method of the first aspect of the invention may be determined by size exclusion chromatography as described herein.

The medium molecular weight heparin prepared by the method of the first aspect may comprise at least three units of a GlcNS6S-IdoA2S (or IdoA2S-GlcNS6S) disaccharide. The GlcNS6S and IdoA2S monosaccharides are linked by an @1-4 linkage between GlcNS6S and IdoA2S, i.e. GlcNS6Sa1-4IdoA2S. For example, the medium molecular weight heparin prepared by the method of the first aspect may comprise at least four units, preferably at least five units, preferably at least six units, preferably at least eight units, preferably at least ten units of a GlcNS6S-IdoA2S disaccharide. The medium molecular weight heparin prepared by the method of the first aspect may comprise less than or equal to 25 units of the GlcNS6S-IdoA2S disaccharide, for example less than or equal to 20 units. The presence of the units of the GlcNS6S-IdoA2S disaccharide may be determined by an antibody, mass spectrometry, or inferred from chemical and enzymatical studies. The GlcNS6S-IdoA2S units may be ordered in succession.

“IdoA” is α-L-iduronic acid. “IdoA2S” is IdoA modified by the addition of an O-sulfate group at carbon position 2 to form 2-O-sulfo-α-L-iduronic acid. “GlcNS” is 2-deoxy-2-sulfamido-α-D-glucopyranosyl. “GlcNS6S” is 2-deoxy-2-sulfamido-α-D-glucopyranosyl-6-O-sulfate. An α1-4 linkage is an alpha glycosidic bond between carbon-1 on one monosaccharide and carbon-4 on a second monosaccharide. A β1-4 linkage is beta glycosidic bond between carbon-1 on one monosaccharide and carbon-4 on a second monosaccharide.

The medium molecular weight heparin prepared by the method of the first aspect may comprise UA2S-GlcNS6S, UA2S-GlcNS, UA-GlcNAc, wherein U may be iduronic acid (IdoA) or glucuronic acid (GlcA). The medium molecular weight heparin prepared by the method of the first aspect may comprise at least about 60% UA2S-GlcNS6S, UA2S-GlcNS, and UA-GlcNAc. The medium molecular weight heparin prepared by the method of the first aspect may comprise at least about 45%, preferably at least about 48%, preferably at least about 49%, preferably at least about 60% UA2S-GlcNS6S. The medium molecular weight heparin prepared by the method of the first aspect may comprise up to about 60%, preferably up to about 70%, preferably up to about 85% UA2S-GlcNS6S. The medium molecular weight heparin prepared by the method of the first aspect may comprise at least about 4%, preferably at least about 5%, preferably at least about 6%, preferably at least about 10% UA2S-GlcNS. The medium molecular weight heparin prepared by the method of the first aspect may comprise up to about 15%, preferably up to about 20% UA2S-GlcNS. The medium molecular weight heparin prepared by the method of the first aspect may comprise at least 4%, preferably at least 5%, preferably at least 6%, preferably at least about 10% UA-GlcNAc. The medium molecular weight heparin prepared by the method of the first aspect may comprise up to about 15%, preferably up to about 20% UA-GlcNAc. In some embodiments the medium molecular weight heparin prepared by the method of the first aspect may comprise at least 49.2% UA2S-GlcNS6S, 5.4% UA2S-GlcN and 5.4% UA-GlcNAc. In some embodiments the medium molecular weight heparin prepared by the method of the first aspect may comprise at least 82% UA2S-GlcNS6S, 9% UA2S-GlcNS and 9% UA-GlcNAc. The percentage composition of UA-GlcNAc comprised in the medium molecular weight heparin may be enriched compared to unfractionated heparin.

“UA” is a uronic acid, which is a hexose with a negatively charged carboxylate at the 6-position. The uronic acid may independently be glucuronic acid or iduronic acid. “UA2S” is UA modified by the addition of an O-sulfate group at carbon position 2 to form 2-O-sulfo-uronic acid. “GlcA” is β-D-glucuronic acid “GlcNAc” is 2-deoxy-2-acetamido-α-D-glucopyranosyl.

The method of the first aspect comprises the following steps: (a) dissolving unfractionated (UF) heparin in an aqueous buffer solution adjusted to between about pH 5.0 and about pH 9.0 to provide a first solution; (b) adding an oxidising agent to the first solution to provide a second solution; and (c) incubating the second solution at a temperature of from about 0° C. to about 10° C. to form a medium molecular weight heparin solution.

UF heparin may be obtained from bovine or porcine tissue, for example porcine intestine or bovine lung.

“Buffer” refers to a chemical which, in a solution, resists a change in pH when acid or alkali is added to the solution. Typically, a buffer solution (or buffer system) comprises a weak acid and its conjugate base, or a weak base and its conjugate acid.

Typically, a suitable buffer comprises an acid with a pKa value that lies within ±1 of the desired pH of the formulation. For example, if the desired pH of the formulation is about 7.0, a suitable buffer comprises a weak acid with a pKa value of from about 6.0 to about 8.0. If the acid of a buffer has more than one pKa value (i.e. each molecule of the acid is able to donate more than one proton), in order for the buffer to be suitable, at least one of the pKa values should lie within the desired pH range.

The weak acid and conjugate base (or weak base and conjugate acid) of the buffer are in equilibrium with one another. In accordance with Le Chatelier's principle (if a constraint, such as a change in concentration of a reactant, is applied to a system in equilibrium, the equilibrium will shift so as to counteract the effect of the constraint), addition of acid or base to the solution shifts the position of equilibrium in favour of the conjugate base or weak acid, respectively. Consequently, the concentration of free protons in the formulation (and thus the pH) is relatively unchanged.

Suitable buffer systems comprise an acetate salt and acetic acid (pka=4.75), a citrate salt and citric acid (pka=3.13, 4.76 and 6.40), and phosphoric acid (pka=2.14, 7.20 and 12.37), or mixtures thereof. Phosphate buffered saline may also be used. The pKa values cited herein are those reported at 25° C. in water. Typically, the buffer comprises only one of the pairs listed above, i.e. one acid and its conjugate base. The buffer may comprise an acetate salt and acetic acid, a citrate salt and citric acid, or a phosphate salt and phosphoric acid.

The pH is adjusted to ensure that the pH of the first solution is between from about pH 5.0 to about pH 9.0 because dissolving unfractionated heparin may result in the pH of the aqueous buffer solution changing.

Optionally, in step (a), the aqueous buffer solution is adjusted to between about pH 6.0 and about pH 8.0, more preferably to about pH 7.0. Typically, the temperature of the aqueous buffer solution in step (a) is from about −2° C. to about 4° C. Preferably, the temperature of the aqueous buffer solution in step (a) is from about 0° C. to about 2° C.

Typically, the aqueous buffer solution is a phosphate buffer, a citrate buffer or an acetate buffer, i.e. the buffering system is phosphate, citrate or acetate. Preferably, the aqueous buffer solution is a phosphate buffer, more preferably the aqueous buffer solution is a sodium phosphate buffer or a potassium phosphate buffer, i.e. the buffering system is sodium phosphate or potassium phosphate.

The buffering system in the aqueous buffer solution may be present at a concentration of from about 10 mM to about 100 mM, more preferably from about 20 mM to about 90 mM, more preferably from about 30 mM to about 80 mM, more preferably from about 40 mM to about 70 mM, more preferably from about 50 mM to about 60 mM. The buffering system in the aqueous buffer solution may be present at a concentration of about 50 mM.

The concentration of UF heparin in the aqueous buffer solution may be from about 0.5 mg/ml to about 10 mg/ml, more preferably from about 1 mg/ml to about 8 mg/mL, more preferably from about 1.5 mg/ml to about 6 mg/mL, more preferably from about 2 mg/ml to about 4 mg/ml. The concentration of UF heparin in the aqueous buffer solution may be about 1.5 mg/mL, more preferably about 1.8 mg/mL, more preferably about 2 mg/ml, more preferably about 2.5 mg/ml, more preferably about 2.7 mg/mL, more preferably about 3 mg/mL.

The oxidising agent may be a periodate, for example sodium periodate or potassium periodate. Preferably, the oxidising agent is sodium periodate. Alternatively, or additionally, the oxidising agent may be a perchlorate, for example sodium perchlorate. Preferably, the oxidising agent does not comprise a perchlorate. Use of a perchlorate in combination with a periodate as the oxidising agent results in an increased level of sample breakdown to smaller molecular weight species.

The concentration of the oxidising agent in the aqueous buffer solution may be from about 1 g/L to about 10 g/L. Preferably, the concentration of the oxidising agent may be from about 2 g/L to about 9 g/L, more preferably from about 4 g/L to about 8 g/L, more preferably from about 5 g/L to about 7 g/L. Preferably the concentration of oxidising agent is about 5.7 g/L. Preferably the concentration of the oxidising agent is 5.7 g/L and the oxidising agent is sodium periodate.

The molar ratio of UF heparin to oxidising agent may be from about 1:1 to about 1:200, more preferably from about 1:2 to about 1:150, more preferably from about 1:10 to about 1:100, more preferably from about 1:20 to about 1:50, more preferably from about 1:30 to about 1:40. Typically, the molar ratio of UF heparin to oxidising agent may be about 1:40.

Typically, the incubation temperature in step (c) is from about 0° C. to about 10° C., more preferably from about 1° C. to about 9° C., more preferably from about 2° C. to about 8° C., more preferably from about 3° C. to about 7° C., more preferably from about 4° C. to about 6° C. Preferably, the incubation temperature in step (c) is about 4° C. Typically, the incubating step (c) is carried out for from about 1 hour to about 48 hours, more preferably from about 4 hours to about 36 hours, more preferably from about 8 hours to about 30 hours, more preferably from about 12 hours to about 24 hours, more preferably from about 15 hours to about 20 hours, more preferably from about 16 to about 18 hours. Optionally, step (c) may be carried out at from about 20 to about 25° C.

Incubation step (c) of the first aspect of the invention may be carried out in a laboratory fridge set at the required temperature. The laboratory fridge may be set at a temperature of from about 0° C. to about 10° C., more preferably from about 2° C. to about 8° C., more preferably from about 3° C. to about 7° C., more preferably from about 4° C. to about 6° C. Preferably, the laboratory fridge may be set at a temperature of about 4° C.

The method of the first aspect may further comprise step (d), the step of inactivating the oxidising agent in the medium molecular weight heparin solution. The oxidising agent may be inactivated by the addition of an inactivating agent selected from the group consisting of: D-mannitol, glycerol, N-acetylmethionine, sodium sulfite, and combinations thereof. A particularly preferred inactivating agent is D-mannitol.

The molar ratio of the oxidising agent to the inactivating agent may be from about 1:1 to about 1:10, more preferably from about 1:2 to about 1:8, more preferably from about 1:3 to about 1:6, more preferably from about 1:4 to about 1:5. Typically, the molar ratio of the oxidising agent to the inactivating agent may be about 1:2 or about 1:4.

The method of the first aspect may further comprise step (e), the step of dialysing the medium molecular weight heparin solution in a dialysate to provide a dialysed medium molecular weight heparin sample.

“Dialysis” or “dialysing” means the process of separating molecules in solution by the difference in their rates of diffusion through a semipermeable membrane, for example dialysis tubing. The sample for dialysis and a dialysate (or buffer) are placed on opposite sides of the semipermeable membrane. Target sample molecules (e.g. proteins, DNA or polysaccharides) that are larger than the membrane pores remain on the sample side of the membrane. Contaminants such as small molecules and salts can pass through the membrane into the dialysate, thereby reducing the concentration of contaminants in the sample to low levels. Changing the dialysate for fresh dialysate removes the contaminants that have passed from the sample to the dialysate. This allows more contaminants to diffuse from the sample into the dialysate.

Dialysis can separate small molecules such as salts, reducing agents, or dyes, from larger macromolecules such as proteins, DNA or polysaccharides. Dialysis can also be used to separate polysaccharides by molecular weight. The semipermeable membrane is typically made of a film of regenerated cellulose or cellulose esters.

Dialysis may be carried out by placing a dialysis tubing containing a sample in a dialysate. A “dialysate” is the fluid into which material passes from the dialysis tubing. The dialysate may be refreshed as often as necessary to achieve optimum separation. The dialysis may be carried out over a period of about 1 day to about 14 days, preferably about 5 days to about 10 days, preferably about 7 days. The dialysate may be refreshed about 1 time a day to about 10 times a day, preferably about 2 times a day to about 5 times a day, preferably about 3 times a day. Typically, the dialysate is many times the volume of the sample, for example from about 2 to about 500 times the volume of the sample. The dialysate may be about 4 times the volume of the sample.

Typically, in step (e), the dialysate is water. Optionally, the dialysate may comprise electrolytes such as sodium, potassium, magnesium, calcium, chloride, bicarbonate, lactate, glucose, amino acids, or combinations thereof.

The dialysing step (e) may be carried out in 2 kD cut off tubing, for example provided by Spectra/Por®. The skilled person is aware of the appropriate tubing cut off size for different purposes. Alternatively, the dialysing step (e) may be carried out in a dialysis device or dialyzer. Suitable dialyzers may be the Slide-A-Lyzer™, the Float-A-Lyzer, the Pur-A-lyzer, the D-Tube, and GeBAflex Dialyzers product lines.

The method of the first aspect may further comprise step (f), the step of isolating the medium molecular weight heparin from the dialysed heparin sample. The medium molecular weight heparin may be isolated from the dialysed heparin sample by freeze-drying, centrifuging, or filtration. Preferably, the medium molecular weight heparin is isolated from the dialysed heparin sample by freeze-drying.

“Freeze drying” (also known as lyophilisation or cryodesiccation) is a drying process carried out at low temperature. Freeze drying generally involves reducing temperature and pressure to below the substance's triple point and removing the frozen solvent (e.g. water ice) by sublimation. For aqueous compositions, such as those disclosed herein, freeze drying may be carried out at temperatures of from about −20° C. to about −80° C., preferably about −40° C., and pressures of from about 1000 Pa (0.01 bar) to about 10 Pa (0.0001 bar).

The MMWH may be purified by any suitable method known to the skilled person. Thus, the method may further comprise step (g), the step of purifying the medium molecular weight heparin. For example, the MMWH may be purified by exhaustive dialysis using phosphate buffer (pH=7.0) or saline, a desalting column (e.g. Sephadex G-25 with phosphate buffer (pH=7.0) or saline used as the mobile phase) or precipitation of the MMWH.

The method may include an alkaline elimination step. Alternatively, the method may not include an alkaline elimination step. Alkaline elimination may be carried out using an alkali salt such as, for example, sodium hydroxide, potassium hydroxide or lithium hydroxide. The alkaline elimination step may be carried out by addition of an alkali salt to increase the pH of the medium molecular weight heparin solution to about pH 10 to about pH 14, preferably about pH 12, for about 10 minutes to about 3 hours, preferably about 30 minutes, at about room temperature.

Preferably, the method does not include an alkaline elimination step. Preferably, the method does not include the addition of an alkali metal salt, for example an alkali metal salt such as NaOH, KOH or LiOH. Preferably, the method does not include the addition of NaOH, KOH or LiOH. Surprisingly, a method that does not include an alkaline elimination step or the addition of an alkali metal salt produces medium molecular weight heparin as defined herein that displays very low activity against Factor IIa and/or Xa as compared to UF heparin and low molecular weight heparin.

MMWH may be characterised by NMR, disaccharide analysis, ristocetin-induced platelet aggregation (RIPA), Factor X analysis.

This method is suitable for preparing medium molecular weight heparin on the milligram, gram or kilogram scale.

Advantageously, the method of the first aspect provides medium molecular weight heparin reliably, in good purity, and with reduced degradation.

The method may include the further step (h) comprising incubating the medium molecular weight heparin with a reducing agent to produce reduced medium molecular weight heparin (MMMWH-Red). Preferably, the reducing agent is a mild reducing agent. The reducing agent may be sodium borohydride (NaBH₄), sodium cyanoborohydride (NaBH₃CN), sodium triacetoxyborohydride (NaBH(OAc)₃) or potassium borohydride (KBH₄).

Preferably, step (h) is carried out at between about 10° C. and about 30° C., or between about 15° C. and about 25° C., or between about 20° C. and about 25° C. Preferably, step (f) is carried out at about 25° C. Typically, step (f) is carried out for from about 1 hour to about 24 hours, more preferably from about 2 hours to about 16 hours, more preferably from about 3 hours to about 12 hours, more preferably from about 6 hours to about 10 hours.

The solvent for step (h) may typically be selected from the group consisting of methanol, ethanol, water, THF, or combinations thereof. Preferably, the solvent in step (h) is water.

The method of synthesis of medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; and (d) purifying the medium molecular weight heparin.

The method of synthesis of medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; and (e) purifying the medium molecular weight heparin.

The method of synthesis of medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; and (e) dialysing the medium molecular weight heparin solution in a dialysate to provide a dialysed medium molecular weight heparin sample.

The method of synthesis of medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; (e) dialysing the medium molecular weight heparin solution in a dialysate to provide a dialysed medium molecular weight heparin sample; and (f) Isolating the medium molecular weight heparin from the dialysed heparin sample.

In a second aspect, the invention provides a kit suitable for preparing medium molecular weight heparin, wherein the kit comprises (a) unfractionated heparin; (b) an aqueous buffer solution adjusted to between about pH 5.0 and about pH 9.0; (c) an oxidising agent; and (d) optionally, an inactivating agent.

MMWH produced by the method of the first aspect of the invention includes two aldehyde groups on the glucuronic acid. In some situations, the reactivity of the aldehyde groups may result in reaction of the aldehyde groups with amine residues on proteins within the body via a Schiff base reaction.

Thus, in a third aspect, the invention provides a method of preparing reduced medium molecular weight heparin (MMWH-Red). MMWH-Red does not comprise aldehyde groups, or comprises fewer aldehyde groups than MMWH. The method of the third aspect comprises the following steps: (a) dissolving unfractionated (UF) heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; and (d) incubating the medium molecular weight heparin with a reducing agent to produce reduced medium molecular weight heparin (MMWH-Red).

The reduced medium molecular weight heparin prepared by the method of the third aspect of the invention may comprise polysaccharide chains with an average molecular mass in the range of about 8000 Da (g/mol) to about 13 000 Da (g/mol), preferably about 10 000 Da (g/mol) to about 12 000 Da (g/mol). The reduced medium molecular weight heparin prepared by the method of the third aspect of the invention may comprise polysaccharide chains with an average molecular mass of about 11 000 Da (g/mol).

The molecular weight of the MMWH-Red prepared by the method of the third aspect of the invention may be determined by size exclusion chromatography as described herein.

The MMWH-Red prepared by the method of the third aspect may comprise at least three units of a GlcNS6S-IdoA2S (or IdoA2S-GlcNS6S) disaccharide. The GlcNS6S and IdoA2S monosaccharides are linked by an α1-4 linkage between GlcNS6S and IdoA2S, i.e. GlcNS6Sa1-4IdoA2S. For example, the MMWH-Red prepared by the method of the third aspect may comprise at least four units, preferably at least five units, preferably at least six units, preferably at least eight units, preferably at least ten units of a GlcNS6S-IdoA2S disaccharide. The MMWH-Red prepared by the method of the third aspect may comprise less than or equal to 25 units of the GlcNS6S-IdoA2S disaccharide, for example less than or equal to 20 units. The presence of the units of the GlcNS6S-IdoA2S disaccharide may be determined by an antibody, mass spectrometry, or inferred from chemical and enzymatical studies. The GlcNS6S-IdoA2S units may be ordered in succession.

The MMWH-Red prepared by the method of the first aspect may comprise UA2S-GlcNS6S, UA2S-GlcNS, UA-GlcNAc, wherein U may be iduronic acid (IdoA) or glucuronic acid (GlcA). The medium molecular weight heparin prepared by the method of the third aspect may comprise at least about 60% UA2S-GlcNS6S, UA2S-GlcNS, and UA-GlcNAc. The MMWH-Red prepared by the method of the third aspect may comprise at least about 45%, preferably at least about 48%, preferably at least about 49%, preferably at least about 60% UA2S-GlcNS6S. The MMWH-Red prepared by the method of the third aspect may comprise up to about 60%, preferably up to about 70%, preferably up to about 85% UA2S-GlcNS6S. The MMWH-Red prepared by the method of the third aspect may comprise at least about 4%, preferably at least about 5%, preferably at least about 6%, preferably at least about 10% UA2S-GlcNS. The MMWH-Red prepared by the method of the third aspect may comprise up to about 15%, preferably up to about 20% UA2S-GlcNS. The MMWH-Red prepared by the method of the third aspect may comprise at least 4%, preferably at least 5%, preferably at least 6%, preferably at least about 10% UA-GlcNAc. The MMWH-Red prepared by the method of the third aspect may comprise up to about 15%, preferably up to about 20% UA-GlcNAc. In some embodiments the MMWH-Red prepared by the method of the third aspect may comprise at least 49.2% UA2S-GlcNS6S, 5.4% UA2S-GlcN and 5.4% UA-GlcNAc. In some embodiments the MMWH-Red prepared by the method of the third aspect may comprise at least 82% UA2S-GlcNS6S, 9% UA2S-GlcNS and 9% UA-GlcNAc. The percentage composition of UA-GlcNAc comprised in the MMWH-Red may be enriched compared to unfractionated heparin.

The reducing agent may be sodium borohydride (NaBH₄), sodium cyanoborohydride, sodium triacetoxyborohydride or potassium borohydride (KBH₄). Preferably, the reducing agent is sodium borohydride.

Typically the reducing agent is used at greater than about 0.5 molar equivalents, or greater than about 1 molar equivalent, or greater than about 2 molar equivalents, or greater than about 3 molar equivalents, or greater than about 5 molar equivalents relative to medium molecular weight heparin. Typically the reducing agent is used at less than about 15 molar equivalents, or less than about 12 molar equivalents, or less than about 10 molar equivalents, or less than about 8 molar equivalents, or less than about 6 molar equivalents, or less than about 5 molar equivalents relative to medium molecular weight heparin. The reducing agent may be used in amount of between about 0.5 molar equivalents and about 15 molar equivalents, or between about 1 molar equivalents and about 10 molar equivalents, or between about 2 molar equivalents and about 6 molar equivalents.

Typically, step (d) is carried out at between about 0° C. and about 30° C., or between about 5° C. and about 25° C., or between about 10° C. and about 20° C. Preferably, step (d) is carried out at about 25° C. Typically, step (d) is carried out for from about 1 hour to about 24 hours, more preferably from about 2 hours to about 16 hours, more preferably from about 3 hours to about 12 hours, more preferably from about 6 hours to about 10 hours.

The solvent for step (d) may typically be selected from the group consisting of methanol, ethanol, water, THF, dichloroethane, or combinations thereof. Preferably, the solvent in step (d) is water.

The method of the first aspect may further comprise the step of inactivating the oxidising agent in the MMWH-Red solution. The oxidising agent may be inactivated by the addition of an inactivating agent selected from the group consisting of: D-mannitol, glycerol, N-acetylmethionine, sodium sulfite, and combinations thereof. A particularly preferred inactivating agent is D-mannitol.

The molar ratio of the oxidising agent to the inactivating agent may be from about 1:1 to about 1:10, more preferably from about 1:2 to about 1:8, more preferably from about 1:3 to about 1:6, more preferably from about 1:4 to about 1:5. Typically, the molar ratio of the oxidising agent to the inactivating agent may be about 1:2 or about 1:4.

The MMWH-Red may be purified by any suitable method known to the skilled person. Thus, the method may further comprise the step of purifying the medium molecular weight heparin. For example, the MMWH-Red may be purified by exhaustive dialysis using phosphate buffer (pH=7.0) or saline, a desalting column (e.g. Sephadex G-25 with phosphate buffer (pH=7.0) or saline used as the mobile phase) or precipitation of the MMWH-Red.

For example, the method may further comprise dialysing the medium molecular weight heparin solution in a dialysate to provide a dialysed medium molecular weight heparin sample prior to the reducing step.

This method is suitable for preparing reduced medium molecular weight heparin on the milligram, gram or kilogram scale.

Advantageously, the method of the third aspect provides reduced medium molecular weight heparin reliably, in good purity, and with reduced degradation.

The method of synthesis of reduced medium molecular weight heparin may consist of or consist essentially of the steps: (a) dissolving unfractionated (UF) heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) incubating the medium molecular weight heparin with a reducing agent to produce reduced medium molecular weight heparin (MMWH-Red); and (e) purifying the MMWH-Red.

The method of synthesis of reduced medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; (e) incubating the medium molecular weight heparin with a reducing agent to produce reduced medium molecular weight heparin (MMWH-Red); and (f) purifying the MMWH-Red.

The method of synthesis of reduced medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; (e) dialysing the medium molecular weight heparin solution in a dialysate to provide a dialysed medium molecular weight heparin sample; (f) incubating the dialysed medium molecular weight heparin with a reducing agent to produce reduced medium molecular weight heparin (MMWH-Red); and (g) purifying the MMWH-Red.

The method of synthesis of reduced medium molecular weight heparin may consist of or consist essentially of the steps: (a) dissolving unfractionated heparin in an aqueous buffer solution adjusted to between about pH 5.0 and about pH 9.0 to provide a first solution; (b) adding an oxidising agent to the first solution to provide a second solution; (c) incubating the second solution at a temperature of from about 0° C. to about 10° C. to form a medium molecular weight heparin solution; (d) inactivating the oxidising agent in the medium molecular weight heparin solution; (e) dialysing the medium molecular weight heparin solution in a dialysate to provide a dialysed medium molecular weight heparin sample; (f) Isolating the medium molecular weight heparin from the dialysed heparin sample; (g) incubating the medium molecular weight heparin with a reducing agent to produce reduced medium molecular weight heparin (MMWH-Red); and (h) purifying the MMWH-Red.

Preferably, the reducing agent is a mild reducing agent. The mild reducing agent may selectively reduce aldehydes and ketones to alcohols in the presence of esters. In other words, the mild reducing agent reduces aldehydes and ketones to alcohols at a faster rate than it reduces esters to alcohols. The mild reducing agent does not reduce carboxylic acids, nitriles, and amides under normal conditions. Preferably, the mild reducing agent may be sodium borohydride (NaBH₄).

Preferably, the method does not include an alkaline elimination step. Preferably, the method does not include the addition of an alkali metal salt, for example an alkali metal salt such as NaOH, KOH or LiOH. Preferably, the method does not include the addition of NaOH, KOH or LiOH. Surprisingly, a method that does not include an alkaline elimination step or the addition of an alkali metal salt produces MMWH-Red as defined herein that displays very low activity against Factor IIa and/or Xa as compared to UF heparin and low molecular weight heparin.

For the avoidance of doubt, embodiments related to first aspect of the invention apply mutatis mutandis to the third aspect of the invention.

Both MMWH and MMWH-Red inhibit von Willebrand Factor, and so are appropriate active pharmaceutical ingredients (APIs) and drug products for the purposes of the invention.

Advantageously, MMWH-Red may display greater stability as an API and drug product compared to MMWH. Furthermore, MMWH-Red may reduce the potential for side reaction with excipients comprised in the drug product and MMWH-Red may reduce interactions with proteins in vivo.

In a fourth aspect, the invention provides reduced medium molecular weight heparin (MMWH-Red). MMWH-Red may be prepared according to the first or third aspect of the invention.

MMWH-Red does not comprise an aldehyde or comprises fewer aldehydes than MMWH produced according to the first aspect. The presence of an aldehyde or lack thereof may be determined using 2,4-Dinitrophenyl Hydrazine test. MMWH-Red may not produce an orange-yellow precipitate with reacted with 2,4-dinitrophenylhydrazine or less orange-yellow precipitate than a corresponding amount of starting material. Alternatively, the reduction of MMWH to MMWH-Red may be monitored by infra-red spectroscopy.

MMWH-Red may be characterised by NMR, disaccharide analysis, ristocetin-induced platelet aggregation (RIPA), Factor X analysis.

In a fifth aspect, the invention provides MMWH-Red produced according to the following steps:
(a) dissolving unfractionated (UF) heparin in an aqueous buffer solution adjusted to between about pH 5.0 and about pH 9.0 to provide a first solution;
(b) adding an oxidising agent to the first solution to provide a second solution;
(c) incubating the second solution at a temperature of from about 0° C. to about 10° C. to form a medium molecular weight heparin solution; and
(d) incubating the medium molecular weight heparin with a reducing agent to produce reduced medium molecular weight heparin.

For the avoidance of doubt, embodiments related to first and third aspects of the invention apply mutatis mutandis to the fifth aspect of the invention.

In a sixth aspect, the invention provides a composition comprising MMWH-Red. Preferably, the composition is a pharmaceutical composition.

For the avoidance of doubt, embodiments related to first and third aspects of the invention apply mutatis mutandis to the sixth aspect of the invention.

As described herein, endotheliopathy may be associated with a number of diseases. MMWH-Red inhibits von Willebrand factor. The Inventor has found that MMWH-Red can be used to treat endotheliopathy, particularly endotheliopathy in a patient having a high plasma von Willebrand factor level.

While endotheliopathy may be caused by a large number of diseases and/or conditions as described herein, endotheliopathy with reference to COVID-19 or SARS-COV-2 will primarily be discussed herein. The skilled person will understand that this discussion is merely to provide an example and should not be considered limiting on the present invention.

In late 2019, in Wuhan, China a new beta-coronavirus (Severe Acute Respiratory Syndrome Coronavirus 2, SARS-COV-2) was identified, causing coronavirus disease 2019 (COVID-19). Thereafter, a rapid geographical progression of COVID-19 culminated in the WHO declaring a pandemic in March 2020 (1). The clinical manifestations of those infected with SARS-COV-2 range from the asymptomatic patient to a more severe pneumonia, which can lead to acute respiratory distress syndrome (ARDS) and multi-organ failure. The majority of symptomatic patients will experience a mild-to-moderate form of the disease, which most commonly does not require hospitalisation (2-4). However, there is a cohort of patients that can progress to the more severe form of the disease, where evolution of symptoms/clinical manifestations can take up to 2 weeks, starting from an initial prodromal stage through to ARDS (3). It is now known that the subgroup of patients that become critical and require ventilation or extracorporeal membrane oxygenation (ECMO) have very poor outcomes with high rates of mortality that approach 90% (5).

Since the disease was first described it has affected more than 90 million individuals globally. The pathophysiological pathways remain unclear; accordingly, management is supportive. Disease-modifying therapeutics which could be instigated whilst awaiting a specific anti-viral drug or vaccination are lacking. Several lines of evidence point towards endothelial dysfunction as a key pathophysiological mechanism in COVID-19. Prior to the current pandemic, markers of endothelial dysfunction have been shown to be correlated with disease severity and mortality in patients with sepsis (6-9). Recently Varga et al. (10) demonstrated a widespread endothelialitis that affected pulmonary, renal, gastrointestinal and hepatic vessels on post mortem examination of three patients with COVID-19. In one of the cases the authors reported ‘most of the small vessels appeared congested’ and in another case the patient died from bowel ischaemia with evidence of underlying endothelialitis.

Recently, two proposed haemostatic mechanisms have provided insight into an improved understanding of ARDS based on a molecular pathogenesis associated with endotheliopathy that promotes inflammation and coagulation disorder in sepsis and other critical illnesses (11-14): one is the “two-activation theory of the endothelium” in which an endothelial pathogenesis activates the inflammatory pathway and microthrombotic pathway, whilst the other is a novel “two-path unifying theory” of haemostasis in which haemostasis initiates thrombogenesis and promotes micro-thrombogenesis, leading to vascular microthrombotic disease (VMTD) (11,13,15). These two theories are in congruity with one another since the endothelium contributes to initial haemostasis and triggers the molecular mechanisms of thrombogenesis. ARDS is often associated with sepsis from a variety of different causes and has been seen in severe acute respiratory syndrome (SARS) due to SARS-COV (16), Middle East respiratory syndrome (MERS) due to MERS-COV (17) and now COVID-19. Sepsis-associated ARDS often develops with other organ dysfunction such as encephalopathy (18), hepatic failure (19)(20), acute renal failure, and acute necrotizing pancreatitis (21). This multi-organ involvement suggests ARDS may not be the primary disease but is part of an on-going systemic pathogenic mechanism triggered by an infection or another critical illness.

On this basis the underlying physiologic alteration of multi-organ failure in sepsis and other critical illnesses is identified as circulatory dysfunction occurring as a result of an endotheliopathy associated VMTD (EA-VMTD) (14,15). Therefore, the infection triggers an insult to the endothelium, causing an endotheliopathy. This then results in disseminated microthrombosis (DIMT), which may trigger, for example, local hypoxaemia, systemic hypoxia, and/or ischaemia, and as mentioned earlier COVID-19 is now known to be associated with an endothelialitis (10).

A case series of COVID-19 pulmonary autopsies revealed that, alongside diffuse alveolar damage, numerous localised platelet-rich micro-thrombi and foci of haemorrhage were present in the lungs (22). The authors posited a pulmonary-localised thrombotic microangiopathy as key to the pathogenesis of COVID-19 with others also suggesting the micro-thrombosis is a critical driver in the disease process (23). These microcirculatory changes have been clearly demonstrated in the lungs, kidneys and the liver using contrast enhanced ultrasound (24,25). Similar findings have also been seen in the brain (26). Therefore, there is a growing body of evidence that COVID-19 appears to cause an endothelialitis and a diffuse and widespread microthrombosis.

Hypercoagulability and COVID-19 is now widely accepted and studies have shown abnormal levels of D-Dimers with higher levels associated with more severe disease and increased odds ratio of in-hospital mortality (27-30). Several case reports have noted acute pulmonary emboli in patients with COVID-19 pneumonia in the absence of major predisposing factors for venous thromboembolism formation (27,31,32). More recently Panigada et al. have shown that, in addition to raised D-Dimer levels, there was a marked increase in the levels of Factor VIII and von Willebrand factor (VWF) (33). An increase of over 500% in VWF and >350% increase in Factor Vill levels were reported by Escher et al (34) in relation to COVID-19. Furthermore, it has been demonstrated that patients with a thrombocytopaenia were at over 5-fold increased risk of severe disease and those with the lowest platelet counts were associated with the highest mortality (33,35,36) Therefore, both hypercoagulability and thrombocytopaenia appear to be harbingers of severe disease and mortality.

Von Willebrand Factor (VWF) is a multimeric plasma glycoprotein that plays a critical role in haemostasis and thrombosis mediating platelet adhesion to injured and activated vessels. It is synthesized only in megakaryocytes and endothelial cells (ECs) and it is interesting to note that SARS-CoV can directly infect both of these cell types (22,36).

The vast majority of VWF found in the plasma is derived from the VWF synthesised within the ECs, where it is stored within the Weibel Palade Bodies (WPB). Although restricted to ECs there are differences in the synthesis of VWF within the different vascular beds of the body, with the small vessels of the lung and brain expressing higher levels of VWF than similar sized vessels of the liver or kidney and higher levels in venous rather than arterial ECs (37). A major portion of the VWF stored in the WPBs of endothelial cells is made up of ultra-large VWF (ULVWF). These ultra-large VWF multimers are more adhesive than the smaller VWF multimers in the circulation (38). Upon secretion, ULVWF can spontaneously bind platelets. Inflammatory cytokines such as Interleukin-1 and tumour necrosis factor (TNF)-alpha can trigger the exocytosis of WPBs with release of their contents. Thus, plasma level of VWF can be used as a marker of endothelial activation and vascular inflammation and raised levels of VWF have been shown to associate with ARDS and sepsis, and to correlate independently to mortality (39,40).

Upon secretion from ECs, the secreted VWF, which partly enters the circulation and partly binds to the endothelium, is sensitive to shear stress. This shear stress unfolds the VWF and exposes sites for platelet binding, self-association as well as for cleavage via the enzyme ADAMTS13. It has previously been shown these VWF molecules can self-associate into long ‘strings’ in the direction of flow, both arterial and venous, that bind to platelets and are adherent to the endothelium (41-43). A protease, ADAMTS13, cleaves VWF and ULVWF, perfusion of which over these platelet-VWF strings led to them being rapidly removed from the circulation (41). The ULVWF multimers released from the WPBs have a lower shear stress for unfolding and therefore may represent the initiating molecules for this self-assembly process which leads to hyper-adhesive strings capturing platelets. The binding of platelets to the VWF occurs via the GP Ib receptor. The binding site for this receptor is usually not exposed when the VWF is in its globular form and therefore cannot bind to platelets. Once VWF unfurls, secondary to shear stress, the binding site is exposed and binds with high affinity to platelets. The binding of platelets to VWF may cause a conformational change leading to activation of the integrin GPIIbIIIa (also known as a2bB3) and promoting platelet-platelet as well as platelet-VWF cross binding. For this reason, the use of standard anti-platelet agents is likely to be ineffective (Aspirin or P2Y12 inhibitors) or only partially effective in mitigating this pathological process as was suggested by the cohort study of Tremblay et al (44).

This ability to form VWF-platelet rich thrombi in the microvasculature is the hallmark of acquired thrombotic thrombocytopaenic purpura (TTP) in which auto-antibodies to ADAMTS13 are present. It has also been shown that Interleukin-6 (IL-6) can inhibit the cleavage of ULVWF-platelet strings (45). Furthermore, the synthesis of ADAMTS13, at least in cultured cells, is dramatically inhibited by a variety of cytokines including IL-6 and TNF-alpha (46). This suggests that the cytokine storm, and particularly IL-6, may propagate the microthrombosis. However, this also suggests that if intervention is implemented early and there is no spike in the release of cytokines the disease may be more manageable and the rapid deterioration in the clinical status of patients can be averted.

There is now a significant body of evidence to suggest that there is very marked imbalance in the VWF:ADAMTS13 ratio as well as in the levels of high molecular weight VWF multimers (equivalent to ULVWF) in COVID-19. As mentioned earlier very high levels of VWF have been shown previously with the earliest case report to mention this surge in the levels of VWF being that of Escher et al (34). Subsequently, Goshua et al. (47) demonstrated that reported marked elevations in plasma VWF concentrations in patients admitted with COVID-19 with increased levels associated with disease severity-mean VWF antigen levels of 565±199% vs 278±133 for those admitted to an intensive care unit (ICU) compared to those not admitted to ICU (p<0.0001). Next, Rauch et al. (48) looked at the progression of patients with COVID-19 in relationship to their admission VWF. Those with the highest VWF levels required greater levels of oxygen support whereas those patients that had normal VWF levels did not require admission to hospital nor supplementary oxygen (n=10).

Shortly after the Rauch et al. publication Ladikou et al. (49) showed an increase in the VWF antigen levels of patients with COVID-19 admitted to the ICU with a positive correlation seen in the VWF levels and the age of the patients. They reported a median VWF Antigen level of 350% however, and crucially, they also showed a markedly reduced level of ADAMTS13 (49.7%), suggesting loss of the VWF cleaving protease that ordinarily degrades large VWF multimers and reduces its activity. They speculated that excess release of VWF seen in COVID-19 patients leads to depletion of ADAMTS13 and contributes to the prothrombotic state. Further analysis of their data showed that median VWF levels were significantly higher in patients that died (477%) compared to the ones that remained alive (335%) (p=0.015).

Helms et al. (50) recently published a multicentre prospective cohort study in France, assessing thrombotic risk in COVID-19 patients, which showed that VWF and factor VIII were considerably increased. In conjunction with this data showing increases in VWF and reductions in ADAMTS13 there is further research to show that the VWF:ADAMTS13 ratio is substantially deranged. Huisman et al. (51) were the first to show a mean VWF:ADAMTS13 ratio of 8.5 (normal 0.5-2) from 12 patients admitted to the ICU. Subsequently, Mancini et al (52) demonstrated similar findings with an elevated von Willebrand Factor antigen (VWF:Ag) to ADAMTS13 activity ratio that was strongly associated with disease severity with the worst ratio, 8.3, seen in those patients that required high intensity care (intubation and mechanical ventilation) compared to those requiring low intensity care, 3.42 (p<0.001).

Most recently, Philippe et al. (53) published their results from a cohort of 208 patients admitted to two centres in Paris of whom 23 had only mild symptoms and were treated as outpatients. They found that only VWF:Ag scaled according to clinical severity, with levels significantly higher in critical patients (median 507%, IQR 428-596) compared to non-critical patients (288%, 230-350, p<0.0001) or COVID-19 outpatients (144%, 133-198, p=0.007). In a univariable analysis model a VWF:Ag level over 423% at admission was significantly associated with higher in-hospital mortality (OR 89.7 95% CI 25.9-567.4, p<0.001) which remained very significant in a multivariable analysis model adjusted on age, BMI, D-Dimer and C-reactive protein (CRP) (odds ratio, OR 25.6, 95% CI 5.6-198.2, p<0.001). More importantly they showed that VWF high molecular weight multimers (HMWM) were significantly higher in critical patients (median ratio 1.18, IQR 0.86-1.09) compared to non-critical patients (0.96, 1.04-1.39, p<0.001). Furthermore, the levels of HMWM (ratio) (OR 116, 95% CI 10.2-1943, p<0.001) was one of the most significantly associated with in-hospital mortality.

It is possible to develop a unifying theory that is triggered by an endotheliopathy and endothelialitis, which causes the release of VWF and ULVWF resulting in the formation of microthrombi. This then leads to hypoxia and the process can be accentuated by the ‘cytokine storm’ and release of IL-6, which inhibits and reduces the functions of ADAMTS13, resulting in a cascade of disseminated microthrombosis and multi-organ dysfunction and failure. It has also been suggested that this microvascular thrombosis at the pulmonary level is the origin of right ventricular dysfunction (54). This mechanism can account for many of the findings currently being observed including the high D-Dimer levels (high because of the huge levels of microthrombosis), high levels of Factor VIII and VWF (released from the WPBs in response to an endothelial insult), the microthrombosis and atypical ARDS picture being seen (55), as well as the widespread clinical picture of pulmonary, neurological and gastrointestinal symptoms. The endothelialitis and microthrombosis we suggest may also explain why patients with a pre-existing endotheliopathy and micro-arteriopathy (e.g., secondary to diabetes mellitus, hypertension, or obesity) are at increased risk of severe COVID-19 (29,56). Similarly, there is a rapidly growing body of evidence linking patients with low levels of ADAMTS13 and high levels of VWF with a variety of diseases that pre-dispose to a poor outcome after infection with SARS-COV-2 and to its variable presentation (57-64). The use of standard anti-platelet medication (aspirin or P2Y12 inhibitors) is also likely to be ineffective given that the interaction between VWF and platelets activates the GP2b3a receptor. Although the inhibition of VWF-platelet binding via the GP1b receptor, using either caplacizumab or anfibatide, would be an attractive option and has been suggested (65) these drugs are not in widespread use and clinical experience with them is extremely limited. Similarly, they carry a significant haemorrhage profile.

Thus, there is a need for a treatment of endotheliopathy per se.

Heparin is a naturally occurring, highly sulphated polysaccharide characterised by a wide molecular weight range of polysaccharide chains. Heparin acts at a variety of different ligands with varied actions. Heparin is a member of the glycosaminoglycan carbohydrate family and consists of repeating disaccharide units of GlcAβ1-4GlcNAcα1-4 with poly-disperse sulfation, N-acetylation and uronosyl epimerization. Heparin is highly heterogenous. Heparin may be isolated from natural sources, such as porcine intestine or bovine lung. Heparin isolated from natural sources contains polysaccharide chains with molecular weights ranging from about 3000 Da to about 30,000 Da. This is known as unfractionated heparin (UFH). UFH can be enzymatically or chemically treated to deliver shorter polysaccharide chains. Heparinase I cleaves at the α-1,4 linkage between nonacetylated GlcNS6S and IdoA2S. Periodate treatment of UFH followed by alkaline elimination cleaves the polysaccharide chain at unsulfated uronic acid units. The products of the chemically or enzymatically treated UFH can be affinity purified to yield fractionated heparin where the molecular weight of the polysaccharides in each fraction can be readily determined. Low molecular weight heparin (LMWH) contains polysaccharide chains in the range of about 4000 Da to about 8000 Da.

In 1991, it was first demonstrated that the intravenous administration of heparin to patients during open heart surgery induced the impairment of VWF-dependent platelet function, without changes in plasma VWF levels (66). This inhibitory effect of heparin on VWF-dependent platelet agglutination was not dependent on the heparin's affinity for anti-thrombin III, but was dependent upon the molecular weight of heparin. From later in vitro experiments, it was found that heparin bound to a specific amino acid sequence within the A1 domain of VWF (residues 569-583), in which basic amino acids are regularly arranged. Heparin binding induced conformational changes in a peptide of this binding site (67). Heparin bound to both activated and inactivated VWF similarly, but did not interfere with VWF binding to collagen. Since the platelet Gplb-binding domain (residues 524-542) is also located in the A1 domain, it was suggested that heparin interferes with VWF binding to platelet Gplb both by steric hindrance and by inducing a conformational change of the domain that results in inhibition of platelets binding.

The structural specificity of the heparin that is responsible for binding to VWF, revolves around key disaccharide units-GlcNS6S-IdoA2S and IdoA2S-GlcNS6S. This structural unit, which is normally destroyed by heparinase I digestion, was successfully deduced by competitive binding assays using heparin fractions prepared by specific methods of depolymerization of heparin that produce fragments of predictable structure (68). Further, through the study using synthetic and structurally defined oligosaccharides, it was demonstrated that the assembly of more than 3 units of the disaccharide was crucial for the binding potency. Similarly, although fractionated heparins of lower molecular weight (6100 Da (g/mol)) have shown a higher affinity to binding to the VWF they were less able to inhibit VWF activity compared to UFH. This suggests that a minimum heparin molecular weight and molecular size is important in order to achieve steric hindrance.

Medium molecular weight heparins with specific disaccharide units (GlcNS6S-IdoA2S, also written as IdoA2S-GlcNS6S) can be produced from unfractionated heparins. These medium molecular weight heparins may have specificity towards inhibiting VWF-GPlb binding, hence stopping microthrombosis, but as they have little effect on anti-thrombin Ill they have little anti-coagulant effect. Thus, medium molecular weight heparins with a mass of about 11 000 Da (g/mol) may represent an ideal treatment option when considering the treatment of patients with pro-thrombotic states that are dependent upon increased VWF levels and endotheliopathies. Furthermore, the results of these earlier studies suggests that low molecular weight heparins are unlikely to work and target the GPlb receptor and that UFH, whilst it may contain the sugar moieties that can bind to VWF, is sub-optimal. Moreover, monitoring of UFH is difficult and the other fractions of UFH, e.g. the LMWH fractions, have anticoagulant effects which can result in dangerous bleeding events, which are unpredictable.

Of further interest is the fact that it has recently been shown that SARS-COV-2 binds to heparin sulphates and in particular requires the IdoA2S-GlcNS6S sugar moiety (74,75). This suggests that exogenous supply of these sugar moieties may inhibit binding to the endogenous heparan sulphates in the lungs and hence act as a potential prophylactic treatment. Taken together, a specialized medium molecular weight heparin (≈11000 Da (g/mol)) with at least 3 units of the GlcNS6S-IdoA2S disaccharide may inhibit viral adherence and replication but also inhibit the microthrombosis triggered by the release of VWF secondary to the endotheliopathy caused by the virus.

When heparin is exposed to a specific oxidant (eg. IO⁴⁻, periodate ion), the diol portion of the glucoronic acid is broken and two aldehyde groups are formed which as described herein results in MMWH. The result is a significant reduction in the activity as performed by the anti-Xa and anti-IIa tests routinely performed on heparin. It is proposed that this oxidation of the glucuronic acid changes the binding capability of heparin to antithrombin III (ATIII).

However, the ristocetin-induced platelet aggregation (RIPA) test shows an increased activity of the MMWH. This indicates that the von Willebrand factor interaction of the heparin polysaccharide remains intact and possibly enhanced.

The two aldehyde groups on the glucuronic acid may in some circumstances be reactive. This reactivity can potentially decrease the stability of the oxidized polysaccharide over time. Additionally, it may interact with free amines on proteins when injected into the body. The latter would be through a Schiff base reaction with the free amines in the same way as glucose reacts with hemoglobin to form the well known glycated hemoglobin commonly known as A1C.

One potential solution would be to reduce the aldehyde functionalities to alcohol functionalities. The could be easily performed by a mild reducing agent such as sodium borohydride (NaBH₄). This reduction would not reform the cyclic ring of the glucuronic acid monosaccharide and the binding of the MMWH-Red to ATIII would be to be unchanged. However, the reduced MMWH would still maintain the interaction with the von Willebrand factor and be useful for the treatment of endotheliopathy.

Advantages of MMWH-Red include: Maintains von Willebrand activity of MMWH, greater stability as an active pharmaceutical ingredient (API) and drug product, minimal interaction with pharmaceutical excipients, reduced or no reaction with proteins in vivo, minimising side effects.

Hence, in a seventh aspect, the invention provides MMWH-Red according to the fourth or fifth aspect of the invention or a composition according to the sixth aspect of the invention for use in the treatment of endotheliopathy.

The MMWH-Red may inhibit von Willebrand factor (VWF). The MMWH-Red may inhibit multimers of VWF, preferably ultra-large VWF. The MMWH-Red may inhibit the binding of platelets to VWF.

Preferably, the invention provides MMWH-Red or a composition comprising MMWH-Red for use in the treatment of endotheliopathy. Preferably, the invention provides MMWH-Red or a composition comprising MMWH-Red for use in the treatment of endotheliopathy in a patient having a plasma von Willebrand factor antigen to ADAMTS13 ratio of at least about 2. Preferably, the invention provides MMWH-Red or a composition comprising MMWH-Red for use in the treatment of endotheliopathy in a patient having a plasma von Willebrand factor to ADAMTS13 ratio of at least about 2.

The patient may have a VWF:ADAMTS13 ratio of at least about 2, of at least about 4, of at least about 8, or of at least about 10. The patient may have a VWF:ADAMTS13 ratio greater than about 2, greater than about 4, or greater than about 8, or greater than about 10. The patient may have a VWF:ADAMTS13 ratio of about 2-16, about 4-12, or preferably about 6-10. A patient having a VWF to ADAMTS13 ratio of greater than about 8 typically indicates severe illness and often is indicative of a patient deteriorating towards death.

The patient may have a VWF antigen:ADAMTS13 ratio of at least about 2, of at least about 4, of at least about 8, or of at least about 10. The patient may have a VWF antigen:ADAMTS13 ratio greater than about 2, greater than about 4, or greater than about 8, or greater than about 10. The patient may have a VWF antigen:ADAMTS13 ratio of about 2-16, about 4-12, or preferably about 6-10. A patient having a VWF antigen to ADAMTS13 ratio of greater than about 8 typically indicates severe illness and often is indicative of a patient deteriorating towards death.

The level of VWF and ADAMTS13 in the patient may be measured using an ELISA. The ratio may be calculated as described by Huisman et al (Involvement of ADAMTS13 and von Willebrand factor in thromboembolic events in patients infected with SARS-COV-2. Int J Lab Hematol. 2020 October; 42 (5): e211-2). Briefly, the level of the VWF antigen may be determined in international units and the level of ADAMTS13 may be determined in international units and then the ratio of VWF antigen:ADAMTS13 determined.

Normal levels of plasma VWF are in the range of from about 50 IU per dL to about 200 IU per dL. The mean level of plasma VWF in the general population is about 100 IU per dL. High levels of plasma VWF are those of about 200 IU per dL or more, for example from about 200 IU per dL to about 400 IU per dL, from about 225 IU per dL to about 375 IU per dL, from about 250 IU per dL to about 350 IU per dL, from about 275 IU per dL to about 300 IU per dL.

The patient may have a raised VWF antigen level of about 150% or more, of about 175% or more, of about 200% or more, of about 300% or more, of about 350% or more, or about 400% or more, or of about 500% or more. The patient may have a VWF antigen level of up to about 600%, up to about 700%, up to about 800%, or up to about 1000%.

It is noted that levels of plasma VWF may be temporarily raised by infections, inflammation, trauma, and with physical and emotional stressors. Accordingly, the patient may have a non-temporarily raised plasma von Willebrand factor level, for example for at least about six hours, at least about 12 hours, at least about 18 hours or at least about 24 hours. Preferably, the patient may have a raised plasma von Willebrand factor level for at least about one day, at least about two days, at least about three days, at least about four days, at least about five days, at least about six days, or at least about seven days. Even more preferably the patient may have a raised plasma von Willebrand factor level for at least about one week, at least about two weeks, at least about three weeks or at least about four weeks. Yet even more preferably the patient may have a raised plasma von Willebrand factor level for at least about one month, at least about two months, at least about three months, at least about four months, at least about five months, at least about six months or at least about one year. The patient may have a raised plasma von Willebrand factor level for up to about one week, up to about four weeks, up to about two months, up to about four months, up to about six months, or up to about one year.

The MMWH-Red may have a mass of about 11 000 Da (g/mol). The reduced medium molecular weight heparin may comprise at least three units of the GlcNS6S-IdoA2S (or IdoA2S-GlcNS6S) disaccharide.

The endotheliopathy may be caused by any disease. In particular, the endotheliopathy may be caused by COVID-19, infection, viral infection, acute respiratory distress syndrome (ARDS), cancer, bacterial infection, septicaemia, sepsis, cardiovascular disease, diabetes mellitus, trauma, in particular brain or head trauma, burns, inhalational injury, drugs and drug reactions, haematological conditions, subarachnoid haemorrhage, aneurysmal diseases, stroke, or brain parenchymal haemorrhage. The endotheliopathy may be caused by a viral infection, optionally wherein the viral infection is SARS-COV-2. The endotheliopathy may be caused by cancer, in particular leukaemia, lymphoma, myeloma, or a solid organ cancer, such as colon cancer, breast cancer, brain cancer, lung cancer, pancreatic cancer, testicular cancer, prostate cancer, cervical cancer, liver cancer, or skin cancer.

The infection may be bacterial, fungal, or parasitic. The infection may be bacterial. The bacterial infection may be Actinomyces israelii, Bacillus anthracis, Bacteroides fragilis, Bordetella pertussis, Borrelia burgdoferi, Borrelia garinii, Borrelia afzelaii, Borrelia recurrentis, Brucella abortus, Brucella canis, Brucella melitensis, Brucella suis, Campylobacter jejuni, Chlamydia pneumoniae, Chlamydia trachomatis, Chlamydophilia psittaci, Clostridium botulinum, Clostridium difficile, Clostridium perfringens, Clostridium tetani, Corynebacterium diphtheriae, Enterococcus faecalis, Enterococcus faecium, Escherichia coli, Francisella tularensis, Haemophilus influenzae, Helicobacter pylori, Klebsiella pneumoniae, Legionella pneumophila, Leptospira species, Listeria monocytogenes, Mycobacterium leprae, Mycobacterium tuberculosis, Mycoplasma pneumoniae, Neisseria gonorrhoeae, Neisseria meningitidis, Pseudomonas aeruginosa, Nocardia asteroides, Rickettsia rickettsii, Salmonella, Shigella, Spirochaetes Staphylococcus, Streptococcus, Treponema pallidum, Vibrio cholerae, or Yersinia pestis.

The infection may be fungal. The fungal infection may be Aspergillus, Blastomyces, Candida, Coccidioides, Cryptococcus neoformans, Cryptococcus gattii, Histoplasma, mucormycetes, Tinea cruris, Tinea corporis, or Tinea pedis.

The infection may be parasitic. The parasitic infection may be protozoan eye infection, Chagas' disease, leishmaniasis, toxoplasmosis, giardiasis, malaria, microsporidiosis, or Rhinosporidiosis. Preferably, the parasitic infection is malaria.

The viral infection may be SARS-COV-2. SARS-COV-2 is the virus responsible for the disease COVID-19. COVID-19 can result in ARDS. The endotheliopathy may be caused by SARS-COV-2 infection. The endotheliopathy may be caused by COVID-19. The endotheliopathy may be caused by ARDS.

The endotheliopathy may be caused by cancer. The cancer may be leukaemia, lymphoma or myeloma. Alternatively, or additionally the cancer may be solid organ cancer, for example colon cancer, breast cancer, brain cancer, lung cancer, pancreatic cancer, testicular cancer, prostate cancer, cervical cancer, liver cancer, or skin cancer.

The endotheliopathy may be caused by haematological conditions, for example Thrombotic thrombocytopeniarpura, anaemia, or sickle cell disease.

Dysfunctional endothelial cells may allow for the passage of tumour cells circulating in the blood to pass into the tissues. Thus, treating the endotheliopathy may prevent the haematogenous spread of blood borne cancers. The treatment of the endotheliopathy may inhibit the haematogenous spread of cancer. The medium molecular weight heparin may inhibit the haematogenous spread of cancer.

Biomarkers of endotheliopathy may include raised von Willebrand factor (VWF) levels, ultra-large von Willebrand factor (ULVWF) levels, Factor VIII levels as well as other markers such as Syndecan 1, VWF antigen, VWF activity, VWF multimers, ADAMTS13 levels, platelet counts, VCAM-1, ICAM-1, P-selectin levels, VWF:ADAMTS13 ratio or VWF antigen:ADAMTS13 ratio. Preferably, a biomarker of endotheliopathy is the ratio of VWF:ADAMTS13 or VWF antigen:ADAMTS13.

The patient may have raised plasma von Willebrand factor (VWF) levels compared to a healthy control subject. The patient may have sustained high levels of plasma VWF compared to a healthy control. The levels of plasma VWF may be raised compared to a healthy control subject over a period of at least about one day, at least about two days, at least about three days, at least about four days, at least about five days, at least about six days, or preferably at least about one week. The levels of plasma VWF may be raised compared to a healthy control subject for a period of up to about one week, up to about four weeks, up to about two months, up to about four months, up to about six months, or up to about one year.

For example, the level of plasma VWF may be raised to at least about 50 nmol/L, preferably at least about 60 nmol/L, even more preferably at least about 70 nmol/L or yet even more preferably at least about 90 nmol/L. The level of plasma VWF may be raised to about 130 nmol/L, to about 150 nmol/L, or to about 200 nmol/L. The level of plasma VWF may be raised to at least about 50 nmol/L for at least about one day, at least about two days, at least about three days, at least about four days, at least about five days, at least about six days, at least about one week, at least about one month or at least about one year. The level of plasma VWF may be raised to at least about 60 nmol/L for at least about one day, at least about two days, at least about three, days, at least about four days, at least about five days, at least about six days, at least about one week, at least about one month or at least about one year. The level of plasma VWF may be raised to at least about 70 nmol/L for at least about one day, at least about two days, at least about three days, at least about four days, at least about five days, at least about six days, at least about one week, at least about one month or at least about one year. The level of plasma VWF may be raised to at least about 90 nmol/L for at least about one day, at least about two days, at least about three days, at least about four days, at least about five days, at least about six days, at least about one week, at least about one month or at least about one year. The plasma VWF level may be measured using an Enzyme-Linked Immunosorbent Assay (ELISA).

Alternatively or additionally, the patient may have a plasma von Willebrand factor level of about 200 IU pr dL or more for at least about six hours, at least about 12 hours, at least about 18 hours or at least about 24 hours. Preferably, the patient may have a plasma von Willebrand factor level of about 200 IU pr dL or more for at least about one day, at least about two days, at least about three days, at least about four days, at least about five days, at least about six days, or at least about seven days. Even more preferably the patient may have a plasma von Willebrand factor level of about 200 IU pr dL or more for at least about one week, at least about two weeks, at least about three weeks or at least about four weeks. Yet even more preferably the patient may have a plasma von Willebrand factor level of about 200 IU pr dL or more for at least about one month, at least about two months, at least about three months, at least about four months, at least about five months, at least about six months or at least about one year.

Vascular endothelial function can be assessed in the coronary and peripheral circulations. Non-invasive tests for the assessment of coronary endothelial function include Doppler echocardiography where blood flow is measured in response to pharmacological or physiological stimuli. Other tests include positron emission tomography and phase-contrast magnetic resonance imaging. However, the gold standard test involves invasive quantitative coronary angiography to examine changes in diameter in response to intracoronary infusions of endothelium-dependent vasodilators such as acetylcholine. Assessment of the endothelium in the peripheral circulation includes brachial artery ultrasound and strain-gauge venous impedance plethysmography.

Binding of MMWH-Red to VWF may be assessed by a competitive binding assay. Heparin-Sepharose beads may be incubated with labelled VWF, for example ¹²⁵I-vWF, for a period of time to allow the labelled VWF to bind to the immobilized heparin. Varying concentrations of the MMWH-Red may then be added and the amount of displaced labelled VWF determined. Other methods to determine MMWH-Red binding to VWF may include surface plasmon resonance, biolayer interferometry, isothermal titration calorimetry, fluorescence polarisation binding assays, ELISA and microscale thermophoresis.

The inhibition of platelets binding to VWF may be assessed by ristocetin-induced agglutination of fixed platelets. Platelets may be incubated with the medium molecular weight heparin and citrate treated plasma (a VWF source). Ristocetin may then be added, and platelet agglutination then determined. The MMWH may fully inhibit VWF-induced platelet aggregation at a concentration of 15 UM when measured by a ristocetin-induced platelet aggregation assay. Other methods to determine the inhibition of VWF binding to platelets may include ELISA, fluorescence assisted cell sorting, dynamic light scattering, or flow chamber assays.

The MMWH-Red may have a mass in the range of greater than about 8000 Da (g/mol) to about 13 000 Da (g/mol), preferably about 10 000 Da (g/mol) to about 12 000 Da (g/mol). The MMWH-Red may have a mass of about 11 000 Da (g/mol). The MMWH-Red may comprise polysaccharide chains with an average molecular mass in the range of about 9000 Da (g/mol) to about 13 000 Da (g/mol), preferably about 10 000 Da (g/mol) to about 12 000 Da (g/mol). The MMWH-Red may comprise polysaccharide chains with an average molecular mass of about 11 000 Da (g/mol). The molecular weight of the MMWH-Red may be determined by mass spectrometry or size exclusion chromatography, for example.

The MMWH-Red may comprise at least three units of a GlcNS6S-IdoA2S disaccharide, for example at least four units, at least five units, at least six units, at least eight units, or at least ten units. The medium molecular weight heparin may comprise less than or equal to 25 units of the GlcNS6S-IdoA2S disaccharide, for example less than or equal to 20 units. The presence of the units of the GlcNS6S-IdoA2S disaccharide may be determined by an antibody, mass spectrometry, or inferred from chemical and enzymatical studies. The GlcNS6S-IdoA2S units may be ordered in succession.

The MMWH-Red may comprise at least three units of a IdoA2S-GlcNS6S disaccharide, for example at least four units, at least five units, at least six units, at least eight units, or at least ten units. The reduced medium molecular weight heparin may comprise less than or equal to 25 units of the IdoA2S-GlcNS6S disaccharide, for example less than or equal to 20 units. The presence of the units of the IdoA2S-GlcNS6S disaccharide may be determined by an antibody, mass spectrometry, or inferred from chemical and enzymatical studies. The IdoA2S-GlcNS6S units may be ordered in succession. The number of IdoA2S-GlcNS6S units may be tailored to provide a desired anti-VWF activity and/or standard anticoagulant activity.

The MMWH-Red may comprise UA2S-GlcNS6S, UA2S-GlcNS, UA-GlcNAc. The MMWH-Red may comprise at least about 60% UA2S-GlcNS6S, UA2S-GlcNS, and UA-GlcNAc. The MMWH-Red may comprise at least about 45%, preferably at least about 48%, preferably at least about 49%, preferably at least about 60% UA2S-GlcNS6S. The MMWH-Red may comprise up to about 60%, preferably up to about 70%, preferably up to about 85% UA2S-GlcNS6S. The MMWH-Red may comprise at least about 4%, preferably at least about 5%, preferably at least about 6%, preferably at least about 10% UA2S-GlcNS. The MMWH-Red may comprise up to about 15%, preferably up to about 20% UA2S-GlcNS. The MMWH-Red may comprise at least 4%, preferably at least 5%, preferably at least 6%, preferably at least about 10% UA-GlcNAc. The reduced medium molecular weight heparin may comprise up to about 15%, preferably up to about 20% UA-GlcNAc. In some embodiments the MMWH-Red may comprise at least 49.2% UA2S-GlcNS6S, 5.4% UA2S-GlcN and 5.4% UA-GlcNAc. In some embodiments the MMWH-Red may comprise at least 82% UA2S-GlcNS6S, 9% UA2S-GlcNS and 9% UA-GlcNAc. The percentage composition of UA-GlcNAc comprised in the MMWH-Red may be enriched compared to unfractionated heparin.

The treatment of endotheliopathy by MMWH-Red may inhibit the haematogenous spread of cancer. Human tumour cells can bind to VWF under shear flow conditions with both melanoma and colon cancer cells demonstrating this ability. The immobilized platelets, bound to the VWF, have been shown to mediate tethering, rolling, and the firm adhesion of different cancerous cell lines under flow shear stress. The VWF played a critical role in enabling this firm adhesion of the tumour cells to the immobilized platelets. The existing data suggests that VWF plays an important role in tethering cancerous cells. In addition, the VWF-Platelet binding that occurs as part of the normal thrombosis pathways may further act to allow the coalescence of tumour cells into the VWF-Platelet to form heteroaggregates of VWF+platelets+ cancer cells which thereby help in the blood borne (haematogenous) spread of tumour cells. This process may at least in part be caused by the ability of cancer cells to translocate to the vessel wall and thereby spread to other organs once the initial binding to VWF and Platelets has occurred. In addition, various cancers are known to cause an endotheliopathy with the resultant release of UL-VWF. By this mechanism, the tumour triggers the release of UL-VWF that then allows the tethering of platelets and tumour cells and the haematogenous spread of the cancer and the metastatic spread. This cancer induced endotheliopathy also results in an overall increase in the risk of thrombosis in patients with underlying malignancy. Therefore, any treatment aimed at treating an endotheliopathy and inhibiting the binding of platelets and/or tumour cells to VWF would serve a dual purpose of decreasing the risk of malignancy associated thrombosis and also reduce the risk haematogenous metastatic spread.

The MMWH-Red may be administered by an administration method selected from the group consisting of: parenteral, subcutaneous, intravenous, intramuscular, intrathecal, intradermal, intraarterial, intraarticular, cutaneous, transcutaneous, subcutaneous, depot form, for example depot injection, intra-osseus, or inhalation. Preferably, the medium molecular weight heparin administration method is subcutaneous, intravenous or intramuscular. The administration method may be inhalation, optionally via a nebuliser.

Previous studies have looked at UFH as a nebulised agent in a variety of conditions. Small human studies indicate that nebulised UFH limits pulmonary fibrin deposition, attenuates progression of acute lung injury and hastens recovery (69). Early-phase trials in patients with acute lung injury and related conditions found that nebulised UFH reduced pulmonary dead space, coagulation activation, microvascular thrombosis, improved lung injury and increased time free of ventilatory support (70-73). In a pre-pandemic double-blind randomised study in 256 critically ill ventilated patients, nebulised UFH limited progression of lung injury including acute respiratory distress syndrome and accelerated return to home in survivors. Thus, the MMWH-Red may be administered by inhalation via a nebuliser.

Heparin dosage is typically measured in “Howell Units”. One unit of heparin (the “Howell unit”) is an amount approximately equivalent to 0.002 mg of pure heparin, which is the quantity required to keep 1 ml of cat's blood fluid for 24 hours at 0° C. The MMWH-Red may be administered at a bolus does of about 5000 units, followed by about 1200 to about 1600 units per hour optionally delivered by an infusion pump. The MMWH-Red may be administered at a dose of about 18 units/kg to about 5000 units/kg. Preferably, the MMWH-Red may be administered at a dose of about 100 units/kg to about 800 units/kg. Alternatively, the MMWH-Red may be administered at a dose of about 18 units/kg to about 75 units/kg. The MMWH-Red may be administered at a dose of about 5000 units, about 4000 units, about 3000 units, about 2000 units, about 1000 units or about 500 units every 12 hours. The MMWH-Red may be administered at a dose of about 5000 units every 12 hours.

The MMWH-Red may be administered at a dose of about 3 units to about 5000 units, for example from about 6 units to about 4000 units, from about 12 units to about 3000 units, from about 25 units to about 2000 units, from about 50 units to about 1000 units, from about 100 units to about 500 units, or from about 125 units to about 250 units. The reduced medium molecular weight heparin may be administered at a dose of about 18 unit/kg to about 5000 units/kg, for example from about 100 units/kg to about 4000 units per/kg, or from about 200 units/kg to about 800 units/kg. The reduced medium molecular weight heparin may be administered at a dose of about 18 units/kg to about 75 units/kg. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be about 1 day to 7 days, about 2 days to about 6 days, about 3 days to about 5 days, about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered at a dose of about 0.01 mg/kg to about 10 mg/kg, for example at a dose of about 0.05 mg/kg to about 9 mg/kg, about 0.5 mg/kg to about 8 mg/kg, about 1 mg/kg to about 7 mg/kg, about 1.5 mg/kg to about 6 mg/kg, or about 2 mg/kg to about 5 mg/kg. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be about 1 day to about 7 days, about 2 days to about 6 days, about 3 days to about 5 days, about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered at a dose of from about 0.01 mg/kg, from about 0.1 mg/kg, from about 1 mg/kg, from about 5 mg/kg, from about 10 mg/kg, from about 20 mg/kg, from about 30 mg/kg, from about 50 mg/kg, from about 70 mg/kg, from about 80 mg/kg, or from about 100 mg/kg. The MMWH-Red may be administered at a dose of about 500 mg/kg or less, about 300 mg/kg or less, about 200 mg/kg or less, or about 100 mg/kg or less. The MMWH-Red may be administered at a dose of from about 0.01 mg/kg to about 10 mg/kg, preferably from about 0.2 mg/kg to about 10 mg/kg, from about 0.2 mg/kg to about 1.6 mg/kg. The MMWH-Red may be administered as a single dose or as a continuous dose. The MMWH-Red dosage amount may be dependent on the VWF antigen:ADAMTS13 ratio or the overall VWF levels. The skilled person would be able select a suitable amount for a patient based on the VWF antigen:ADAMTS13 ratio or the overall VWF levels.

The MMWH-Red may be administered at a dose of from about 0.01 mg/kg to about 10 mg/kg, from about 0.05 mg/kg to about 8 mg/kg, from about 0.1 mg/kg to about 5 mg/kg, from about 0.5 mg/kg to about 2 mg/kg, from about 1 mg/kg to about 1.5 mg/kg. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be from about 1 day to about 7 days, from about 2 days to about 6 days, from about 3 days to about 5 days, from about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered at a dose of from about 0.1 mg to about 5000 mg, from about 0.5 mg to about 2000 mg, from about 1 mg to about 1000 mg, from about 5 mg to about 900 mg, from about 10 mg to about 800 mg, from about 20 mg to about 700 mg, from about 30 mg to about 600 mg, from about 50 mg to about 500 mg, from about 75 mg to about 400 mg, from about 100 mg to about 300 mg, from about 125 mg to about 250 mg, from about 150 mg to about 200 mg. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be from about 1 day to about 7 days, from about 2 days to about 6 days, from about 3 days to about 5 days, from about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered at a dose of, for example about 1 international units (IU), about 2 IU, about 5 IU, about 10 IU, about 15 IU, about 20 IU, about 25 IU, about 50 IU, about 75 IU, about 100 IU, about 200 IU, about 300 IU, about 400 IU, about 500 IU, about 1000 IU, about 1500 IU, about 2000 IU, about 2500 IU, about 5000 IU, about 10 000 IU, about 20 000 IU, or about 25 000 IU. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be from about 1 day to about 7 days, from about 2 days to about 6 days, from about 3 days to about 5 days, from about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered at a dose of from about 1 IU to about 50 000 IU, from about 2 IU to about 25 000 IU, from about 5 IU to about 20 000 IU, from about 10 IU to about 10 000 IU, from about 15 IU to about 5000 IU, from about 20 IU to about 2500 IU, from about 25 IU to about 2000 IU, from about 50 IU to about 1500 IU, from about 75 IU to about 1000 IU, from about 100 IU to about 500 IU, from about 200 IU to about 400 IU, from about 250 IU to about 300 IU. The dose may be given as a single dose or as a continuous dose. The dose may be given over a period of time. The period of time may be from about 1 month to about 12 months, for example from about 2 months to about 11 months, from about 3 months to about 10 months, from about 4 months to about 9 months, from about 5 months to about 8 months, from about 6 months to about 7 months. The period of time may be from about 1 day to about 7 days, from about 2 days to about 6 days, from about 3 days to about 5 days, from about 4 days to about 5 days. The dose may be administered over about 1 hour to about 24 hours, about 2 hours to about 12 hours, about 3 hours to about 6 hours. The dose may be administered for the duration of the underlying endotheliopathy and raised VWF levels.

The MMWH-Red may be administered that is commensurate with the VWF antigen:ADAMTS13 ratio. For example, a patient with a high VWF antigen:ADAMTS13 ratio may be administered a higher dose of MMWH compared to a patient with a VWF antigen:ADAMTS13 ratio that is lower.

The MMWH-Red may be comprised in a pharmaceutical formulation. The pharmaceutical formulation may comprise an excipient. The excipient may be selected from the group comprising solvents, co-solvents, buffers, stabilisers, antioxidants, preservatives, chelating agents, emulsifiers, flavourings, lubricants, suspending agents, tonicity adjusting agents, surfactants, solubilising agents, suspending aids, dispersion agents, humectants, thickeners, colouring agent, wetting agent, anti-foaming agent, viscosity modifier, sweeteners and combinations thereof. The pharmaceutical formulation may comprise an additional active agent. The additional active agent may comprise medium molecular weight heparin or low molecular weight heparin.

The pharmaceutical formulation may comprise an additional active agent. The additional active agent comprises a composition of matter that has a physiological effect. The additional active agent may comprise low molecular weight heparin or a medium molecular weight heparin or a reduced medium molecular weight heparin of a different disaccharide composition. The additional active agent may be selected from the group comprising farnesoid X receptor (FXR) agonist, a peroxisome proliferator-activator receptor (PPAR) agonist, aramchol, a caspase inhibitor, a galectin 3 inhibitor, a mitogen-activated protein kinase 5 (MAPK5) inhibitor, a fibroblast growth factor 19 (FGF19) agonist, a FGF21 agonist, a leukotriene D4 (LTD4) receptor antagonist, a niacin analog, an apical sodium bile acid cotransporter (ASBT) inhibitor, an apoptosis signal regulating kinase 1 (ASK1) inhibitor, an angiotensin converting enzyme (ACE) inhibitor, an angiotensin receptor blocker, a chemokine receptor inhibitor, a thiozolidinedione, a GLP-1 analog, a biguanide, an HIV replication inhibitor, metoformin, an opiate, an anaesthetic, HMG-COA reductase inhibitor, a nonsteroidal anti-inflammatory drug (NSAID), or any combination of these.

The MMWH-Red may comprise a chemical modification. The chemical modification may be selected from the group comprising N-acetylation, N-deacetylation, N-sulfation, O-sulfation, 2-0 desulfation, and complete desulfation.

In an eighth aspect, the invention provides MMWH-Red for use in the treatment of a disease or condition in a patient, wherein the patient has an endotheliopathy characterised by a plasma von Willebrand factor to ADAMTS13 (VWF:ADAMTS13) ratio of at least about 2.

In an ninth aspect, the invention provides MMWH-Red for use in the treatment of a disease or condition in a patient, wherein the patient has an endotheliopathy characterised by a plasma von Willebrand factor antigen to ADAMTS13 (VWF antigen:ADAMTS13) ratio of at least about 2.

Preferably, the disease or condition is selected from the group consisting of: COVID-19, viral infection, acute respiratory distress syndrome (ARDS), cancer, bacterial infection, septicaemia, sepsis, cardiovascular disease, diabetes mellitus, trauma, in particular brain or head trauma, burns, inhalational injury, drugs and drug reactions, haematological conditions, subarachnoid haemorrhage, aneurysmal diseases, stroke, or brain parenchymal haemorrhage or combinations thereof. The endotheliopathy may be caused by a viral infection, optionally wherein the viral infection is SARS-COV-2. The endotheliopathy may be caused by cancer, in particular leukaemia, lymphoma, myeloma, or a solid organ cancer, such as colon cancer, breast cancer, brain cancer, lung cancer, pancreatic cancer, testicular cancer, prostate cancer, cervical cancer, liver cancer, or skin cancer. Preferably, the endotheliopathy is caused by sepsis or septicaemia. Preferably, the endotheliopathy is caused by sepsis.

In some embodiments, the present invention provides MMWH-Red for use in the treatment of COVID-19 in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of viral infection in a patient, wherein the patient has an endotheliopathy characterised by a VWF:ADAMTS13 ratio of at least about 2 or a plasma von Willebrand factor antigen to ADAMTS13 (VWF antigen:ADAMTS13) ratio of at least about 2. The viral infection may be SARS-COV-2.

In some embodiments, the present invention provides MMWH-Red for use in the treatment of acute respiratory distress syndrome (ARDS) in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of cancer in a patient, wherein the patient has an endotheliopathy characterised by a VWF:ADAMTS13 ratio of at least about 2 or a plasma von Willebrand factor antigen to ADAMTS13 (VWF antigen:ADAMTS13) ratio of at least about 2. The cancer may be leukaemia, lymphoma, myeloma, or a solid organ cancer, such as colon cancer, breast cancer, brain cancer, lung cancer, pancreatic cancer, testicular cancer, prostate cancer, cervical cancer, liver cancer, or skin cancer.

In some embodiments, the present invention provides MMWH-Red for use in the treatment of bacterial infection in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of septicaemia in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of sepsis in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of cardiovascular disease in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of diabetes mellitus in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of trauma in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2. Preferably, the trauma is brain trauma or head trauma.

In some embodiments, the present invention provides MMWH-Red for use in the treatment of burns in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of inhalational injury in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of drug reactions in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of haematological conditions in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of subarachnoid haemorrhage in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

In some embodiments, the present invention provides MMWH-Red for use in the treatment of aneurysmal diseases in a patient, wherein the patient has an endotheliopathy characterised by a plasma VWF:ADAMTS13 ratio of at least about 2 or a plasma von Willebrand factor antigen to ADAMTS13 (VWF antigen:ADAMTS13) ratio of at least about 2.

MMWH-Red for use in the treatment of endotheliopathy as defined in the seventh, eighth or ninth aspect of the invention are particularly advantageous as said heparins can inhibit the microthrombosis triggered by the release of VWF secondary to the endotheliopathy caused by any disease or condition. When the cause of the endotheliopathy is SARS-COV-2, said MMWH-Red can additionally inhibit viral adherence and replication.

In a tenth aspect, the invention provides a method of treating endotheliopathy, the method comprising administering to a subject in need of treatment a therapeutically effective amount of MMWH-Red. Preferably, wherein the patient has plasma VWF:ADAMTS13 ratio of at least about 2 or a plasma von Willebrand factor antigen to ADAMTS13 (VWF antigen:ADAMTS13) ratio of at least about 2.

In a eleventh aspect, the invention provides the use of the MMWH-Red for the manufacture of a medicament for the treatment of endotheliopathy in a patient. Preferably, wherein the patient has plasma VWF:ADAMTS13 ratio of at least about 2 or a plasma von Willebrand factor antigen to ADAMTS13 (VWF antigen:ADAMTS13) ratio of at least about 2.

For the avoidance of doubt, embodiments related to each aspect of the invention apply mutatis mutandis to the other aspects of the invention. Further aspects and embodiments of the present invention will be evident from the discussion herein. Sepsis is the body's extreme response to an infection. It is characterised by a whole-body inflammatory state where as a result of immune response dysregulation, the immune system reacts to the infection by attacking the body's own tissues and organs. Consequently, cells in the body are destroyed through apoptosis or necrosis and intracellular material ends up in the blood stream.

Histones are intracellular basic proteins found in the nucleus of a cell. DNA wraps itself around histones to form chromatin, which is then itself tightly wound to facilitate the packaging of the long DNA molecule into the nucleus of the cell. Whilst known for its role in the packaging of DNA into the nucleus, chromatin (and its constituent histones) have also been shown to play a role in innate immunity. During infection, neutrophils release granular proteins and chromatin that together form extracellular fibres that bind Gram positive and negative bacteria. These neutrophil extracellular traps (NETs) degrade virulence factors and kill bacteria.

Circulating histones have been identified as mediators of damage in animal models of sepsis and in patients. These histones may enter the bloodstream as a result of intracellular material being released due to apoptosis or necrosis which occurs during sepsis, or via NET release in response to bacterial infection. Accordingly, histones may propagate the dysregulation of the immune system observed during sepsis. For example, histones are damage associated molecule patterns (DAMPs) which are sensed by toll-like receptors (TLRs). Activation of TLRs on innate immune cells by histones results in the release of pro-inflammatory cytokines, thereby exacerbating an already dysregulated immune response. In particular, TLR receptors on endothelial cells may be activated by circulating histones, which results in the induction of an immune response in the endothelial cells. Thus, the endothelium becomes inflamed and endothelialitis and endotheliopathy is observed.

Hence, the MMWH or MMWH-Red as defined herein may bind to free histones whilst simultaneously inhibiting VWF, thereby treating sepsis. In an embodiment, the invention provides MMWH or MMWH-Red for the treatment of sepsis, systemic Inflammatory response syndrome (SIRS), severe sepsis or septic shock in a subject. In some embodiments, the subject has plasma VWF:ADAMTS13 ratio of at least about 2.

The MMWH or MMWH-Red as defined herein may be a complement cascade modulator.

The MMWH or MMWH-Red as defined herein may be an immune modulator.

For the avoidance of doubt, embodiments related to each aspect of the invention apply mutatis mutandis to the other aspects of the invention. Further aspects and embodiments of the present invention will be evident from the discussion herein.

Every document cited herein, including any cross-referenced or related patent or application, is hereby incorporated by reference in its entirety unless expressly excluded or otherwise limited.

It will be appreciated that various modifications may be made to the embodiments shown without departing from the spirit and scope of the invention as defined by the accompanying claims.

### Examples

The invention will now be demonstrated by reference to the following non-limiting examples.

Unless otherwise mentioned, room temperature and pressure are 20° C. (293.15 K, 68° F.) and 1 atm (14.696 psi, 101.325 kPa), respectively.

### Experimental Methods

### Size Exclusion Chromatography (SEC)

SEC is performed on a GEC Superdex75 (10/100) column on an Agilent 1200 HPLC system with variable wavelength UV monitor or GEC AKTA system with variable wavelength UV monitor. The mobile phase is 0.15M NaCl in water, which is passed through the column at 0.4 mL/min. The optical density is measured at 232 nm. SEC is performed with reference to an 11 kD standard.

### Freeze Drying

Freeze drying (also known as lyophilisation or cryodesiccation) is a drying process carried out at low temperature. Freeze drying generally involves reducing temperature and pressure to below the substance's triple point and removing the frozen solvent (e.g. water ice) by sublimation. For aqueous compositions, such as those disclosed herein, freeze drying may be carried out at temperatures of from about −20° C. to −80° C., preferably about −40° C., and pressures of from about 1000 Pa (0.01 bar) to about 10 Pa (0.0001 bar).

### Method of MMW Heparin Manufacture

### 1. Development Examples

### 1.1 Optimising Periodate Concentration (Periodate Method)

Batches of 80 mg unfractionated heparin were dissolved in 50 mM sodium phosphate buffer adjusted to pH 7.0 (30 mL).

Samples were prepared with (A) 43 mg, (B) 86 mg, (C) 173 mg or (D) 200 mg sodium periodate added to the heparin in sodium phosphate buffer solution. The resultant solutions were incubated at 4° C. for 16 to 18 hours or at 37° C. for 6 hours.

200 μl aliquots were taken prior to dialysis for SEC. The remainder of the samples were dialysed against water in 2 kd cut off tubing (Spectra/Por®, product number 132109; 7 Days: 3 changes per day/4 volumes of water). The samples were then freeze dried at −40° C. and 10 Pa. The samples were then dissolved in water and analysed by SEC on Superdex® 75 SE (10/300) column in 0.15M NaCl at 0.4 mL/min on either a GEC AKTA system or an Agilent 1200 system.

The aliquots taken prior to dialysis were analysed by SEC on Superdex® 75 SE (10/300) column in 0.15M NaCl at 0.4 mL/min on either a GEC AKTA system or an Agilent 1200 system showed significant amount of disaccharide-like material mixed with the reagent peak.

SEC on the samples was performed and calibrated by coeluting with a verified 11 kDa standard. The SEC analysis of samples following dialysis provided the following results:
a. 37° C. incubation provided a sample that ran as a broad peak centred on Kₐᵥ 0.12 and resulted in degradation of the medium molecular weight heparin.
b. 4° C. incubation provided a sample that ran as a narrower peak centred on Kₐᵥ 0.06 and a molecular weight of 11 kD.

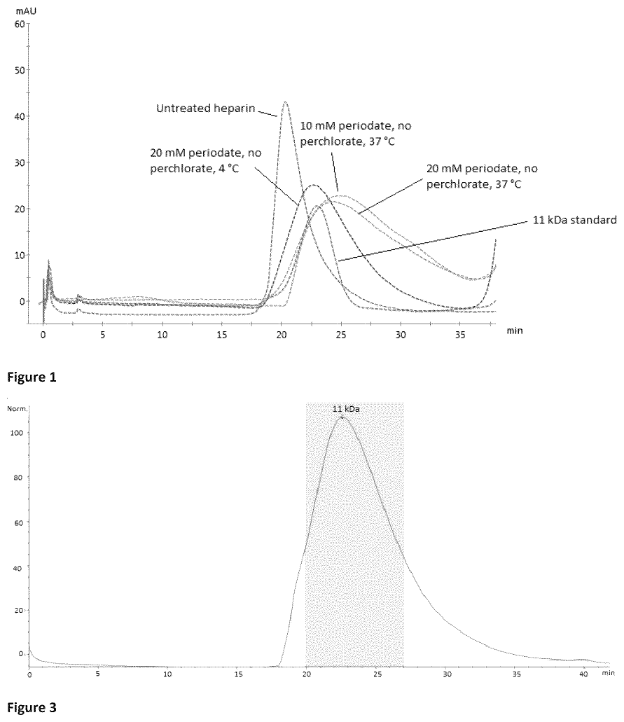

FIG. 1 shows MMWH prepared at 4° C. compared to heparin treated at 37° C., untreated heparin and a 11 kDa standard.

Thus, incubation at 4° C. favours the formation of medium molecular weight heparin. Incubation at 37° C. primarily provides other products.

All investigated concentrations of sodium periodate provided the desired medium molecular weight heparin. The most active concentration of sodium periodate was (C) 173 mg per 30 ml of the heparin in sodium phosphate buffer solution (equivalent to the 8.6 g per 1.5 L used in the large scale process example described below).

### 1.2 Perchlorate Addition

Samples were prepared in accordance with (A) and (B) of the periodate method above (1.1). 732 mg per 30 mL of sodium perchlorate was added to samples (A) and (B) and the resultant solutions were incubated at 4° C. for 16 to 18 hours or at 37° C. for 6 hours.

The samples were dialysed against water in 2 kd cut off tubing (Spectra/Por®, product number 132109; 7 Days: 3 changes per day/4 volumes of water). The samples were then freeze dried at −40° C. and 10 Pa. The samples were then dissolved in water and analysed by SEC on Superdex® 75 SE (10/300) column in 0.15M NaCl at 0.4 mL/min on either a GEC AKTA system or an Agilent 1200 system.

SEC on the samples was performed and calibrated by coeluting with a verified 11 kDa standard. The SEC analysis of samples following dialysis provided the following results:

All samples (incubated at 4° C. and 37° C.) resulted in the production of material with a broader size range centred on Kₐᵥ 0.12. There was also a large increase in material at the Vt of the column (i.e. smaller species).

This examples shows that oxidation with a mixture of periodate and perchlorate results in an increased level of breakdown to smaller species compared to oxidation with periodate alone. Thus, oxidation with only periodate is a more efficient method of preparing high purity medium molecular weight heparin.

### 1.3 Alkaline Elimination

Samples were prepared in accordance with (A) and (B) of the periodate method above at incubations of 4° C. and 37° C. (1.1).

NaOH (2 M) was added to the samples to adjust the pH of the sample to pH 12. The samples were then incubated at room temperature for 30 minutes. Aliquots of these samples were analysed by SEC on Superdex® 75 SE (10/300) column in 0.15M NaCl at 0.4 mL/min on either a GEC AKTA system or an Agilent 1200 system. SEC on the samples was performed and calibrated by coeluting with a verified 11 kDa standard.

This alkaline elimination resulted in further degradation with more defined peaks at Kₐᵥs 0.331, 0.35, 0.4, and 0.54, and a large peak at Kₐᵥ 0.625.

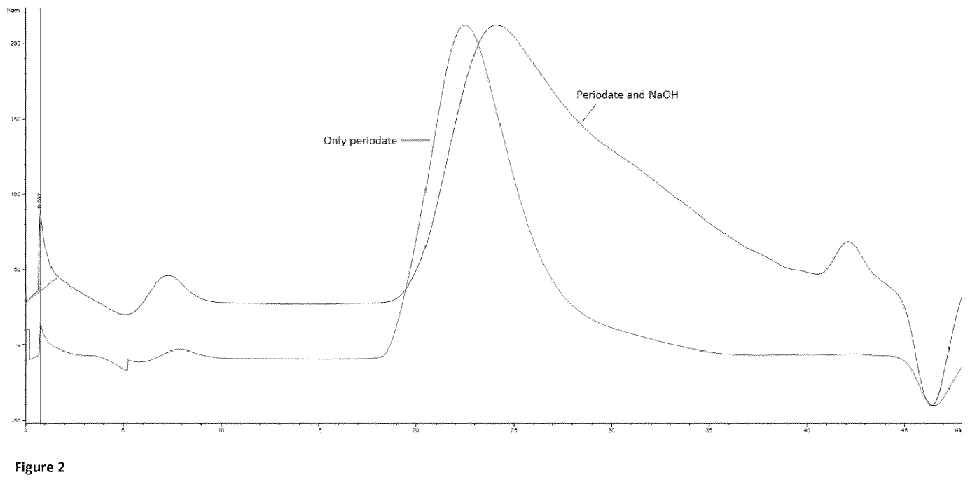

FIG. 2 shows MMWH prepared at 4° C. using only periodate compared to heparin treated with periodate then NaOH at 4° C., which runs as a broad peak due to degradation. Accordingly, the preparation of high purity medium molecular weight heparin is impeded by the inclusion of an alkaline elimination step as significant degradation is observed.

### 2. Large Scale Process Example

UF Heparin (Heparin of Porcine mucosal origin; Iduron Catalog No. HEP001/100) (4 g; 2.7 mg/ml; average molecular weight 15 kDa) was dissolved in ice-cold (0° C. to 2° C.) 50 mM sodium phosphate buffer (1.5 L) adjusted to pH 7.0. Sodium periodate (8.56 g, 40 mmol) was added and the sample was incubated overnight at 4° C. Following incubation, the sodium periodate was inactivated by the addition of D-Mannitol (30 g, 160 mmol).

The sample was then dialysed against water in 2 kD cut off tubing (Spectra/Por®, product number 132109; 7 Days: 3 changes per day/4 volumes of water). The sample was then freeze dried at −40° C. and 10 Pa to provide medium molecular weight heparin in a yield of 2.1 g.

The medium molecular weight heparin sample was then dissolved in water and analysed by SEC on Superdex® 75 SE (10/300) column in 0.15M NaCl at 0.4 mL/min on either a GEC AKTA system or an Agilent 1200 system. The medium molecular weight heparin had an average molecular weight of 11 kDa with reference to a 11 kDa standard as shown in FIG. 3.

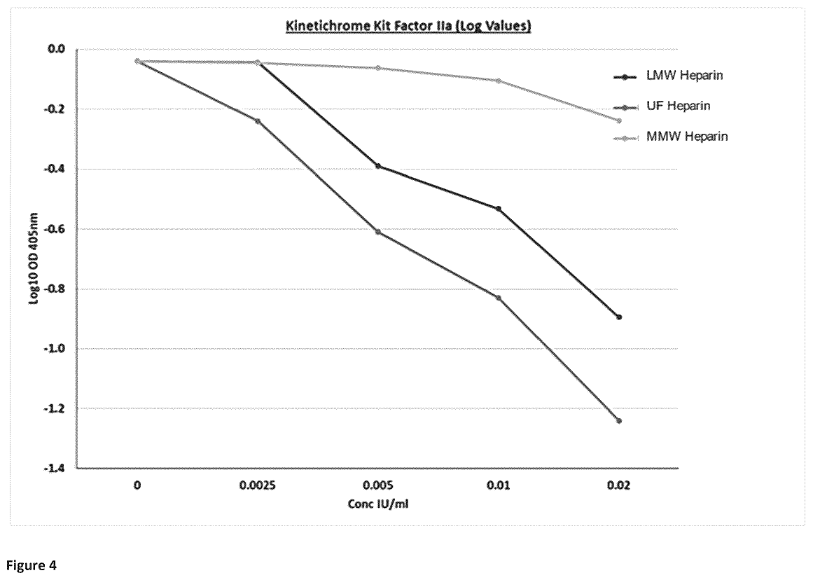

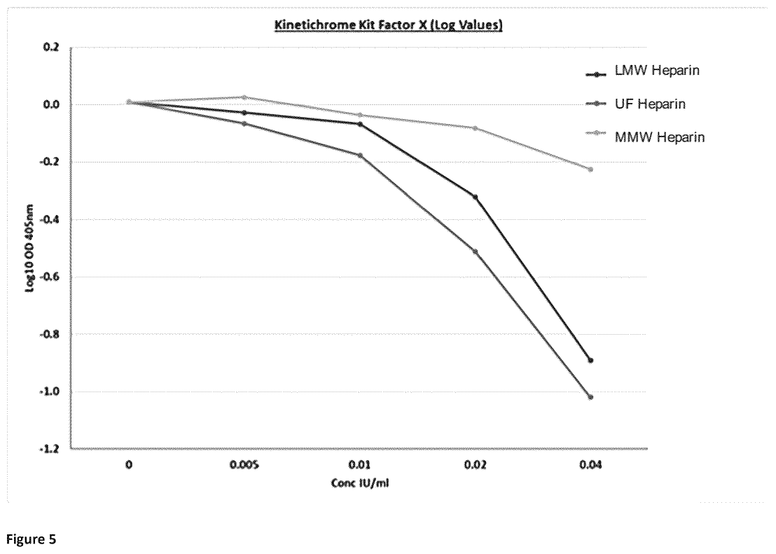

As shown in FIGS. 4 and 5, the medium molecular weight heparin produced displayed very low activity against Factor IIa and/or Xa as compared to UF heparin and low molecular weight heparin. Thus, unlike UF Heparin or LMW Heparin, MMW Heparin does not affect Factor IIa or Factor Xa-mediated coagulation.

Factor IIa (also known as thrombin) acts as a serine protease that converts soluble fibrogen into insoluble strands of fibrin, as well as catalysing other coagulation-related reactions. Factor Xa is the activated form of the coagulation factor X. Factor X is an serine endopeptidase enzyme, which plays a key role at several stages of the coagulation system.

Heparin (unfractionated heparin) and its derivatives, e.g. low molecular weight heparin, bind to a plasma cofactor, antithrombin (AT), to inactivate several coagulation factors IIa, Xa, XIa and XIIa. This inactivation of Factor Xa by heparins is termed “indirect” since it relies on the presence of AT and not a direct interaction with Factor Xa.

Activity against Factor IIa and Factor Xa can be measured using Kinetichrome Anti-IIa Heparin Kit and Kinetichrome Anti-Xa Heparin Kit, respectively.

Disaccharide analysis was carried out on the medium molecular weight heparin. The results are shown in Table 1 below.

| | % Composition medium |
|---|---|
| | molecular weight heparin. |
| Disaccharides | NOTE: only ~60% breakdown |
| ΔUA -GlcNAc | 9.0 |
| UA-GlcNS | — |
| UA-GlcNAc6S | — |
| UA2S-GlcNAc | — |
| UA-GlcNS6S | — |
| UA2S-GlcNS | 9.0 |
| UA2S-GlcNAc6S | — |
| UA2S-GlcNS6S | 82.0 |

UF Heparin of Porcine mucosal origin is used for the purposes of the example synthesis provided herewith. For the avoidance of doubt, other sources of UF heparin are suitable for use in the methods disclosed herein.

### Method of MMWH-Red Manufacture

### Oxidation of Heparin

UFH heparin is oxidised as described above.

### Reduction of the Oxidized Heparin

To a 10 mg/mL solution of the oxidised heparin in deionised water (110 mL) is added 20 mg of sodium borohydride. The reaction mixture is stirred for 3 hours at 25° C. The reduced medium molecular weight heparin is purified by exhaustive dialysis using phosphate buffer (pH=7.0).

### REFERENCES

1. Zhu N, Zhang D, Wang W, Li X, Yang B, Song J, et al. A Novel Coronavirus from Patients with Pneumonia in China, 2019. N Engl J Med. 2020 20; 382 (8): 727-33.
2. Chen N, Zhou M, Dong X, Qu J, Gong F, Han Y, et al. Epidemiological and clinical characteristics of 99 cases of 2019 novel coronavirus pneumonia in Wuhan, China: a descriptive study. Lancet Lond Engl. 2020 15; 395 (10223): 507-13.
3. Huang C, Wang Y, Li X, Ren L, Zhao J, Hu Y, et al. Clinical features of patients infected with 2019 novel coronavirus in Wuhan, China. Lancet Lond Engl. 2020 15; 395 (10223): 497-506.
4. Wang D, Hu B, Hu C, Zhu F, Liu X, Zhang J, et al. Clinical Characteristics of 138 Hospitalized Patients With 2019 Novel Coronavirus-Infected Pneumonia in Wuhan, China. JAMA. 2020 Feb. 7;
5. Ñamendys-Silva SA. Respiratory support for patients with COVID-19 infection. Lancet Respir Med. 2020; 8 (4): e18.
6. Cohen J, Vincent J-L, Adhikari N K J, Machado F R, Angus D C, Calandra T, et al. Sepsis: a roadmap for future research. Lancet Infect Dis. 2015 May; 15 (5): 581-614.
7. Angus D C, van der Poll T. Severe sepsis and septic shock. N Engl J Med. 2013 Aug. 29; 369 (9): 840-51.
8. Johansen M E, Johansson P I, Ostrowski S R, Bestle M H, Hein L, Jensen A L G, et al. Profound endothelial damage predicts impending organ failure and death in sepsis. Semin Thromb Hemost. 2015 February; 41 (1): 16-25.
9. Ostrowski S R, Haase N, Müller R B, Møller M H, Pott F C, Perner A, et al. Association between biomarkers of endothelial injury and hypocoagulability in patients with severe sepsis: a prospective study. Crit Care Lond Engl. 2015 Apr. 24; 19:191.
10. Varga Z, Flammer A J, Steiger P, Haberecker M, Andermatt R, Zinkernagel A S, et al. Endothelial cell infection and endotheliitis in COVID-19. The Lancet [Internet]. 2020 Apr. 20 [cited 2020 Apr. 20]; 0(0). Available from: https://www.thelancet.com/journals/lancet/article/PIIS0140-6736 (20) 30937-5/abstract
11. Chang J C. Hemostasis based on a novel “two-path unifying theory” and classification of hemostatic disorders. Blood Coagul Fibrinolysis Int J Haemost Thromb. 2018 November; 29 (7): 573-84.
12. Chang J C. TTP-like syndrome: novel concept and molecular pathogenesis of endotheliopathy-associated vascular microthrombotic disease. Thromb J. 2018; 16:20.
13. Chang J C. Thrombogenesis and thrombotic disorders based on “two-path unifying theory of hemostasis”: philosophical, physiological, and phenotypical interpretation. Blood Coagul Fibrinolysis Int J Haemost Thromb. 2018 November; 29 (7): 585-95.
14. Chang J C. Disseminated intravascular coagulation: is it fact or fancy? Blood Coagul Fibrinolysis Int J Haemost Thromb. 2018 April; 29 (3): 330-7.
15. Chang J C. Sepsis and septic shock: endothelial molecular pathogenesis associated with vascular microthrombotic disease. Thromb J. 2019; 17:10.
16. Li T S, Gomersall C D, Joynt G M, Chan D P S, Leung P, Hui D S C. Long-term outcome of acute respiratory distress syndrome caused by severe acute respiratory syndrome (SARS): an observational study. Crit Care Resusc J Australas Acad Crit Care Med. 2006 December; 8 (4): 302-8.
17. Gralinski L E, Baric R S. Molecular pathology of emerging coronavirus infections. J Pathol. 2015 January; 235 (2): 185-95.
18. Gonzalvo R, Marti-Sistac O, Blanch L, López-Aguilar J. Bench-to-bedside review: brain-lung interaction in the critically ill—a pending issue revisited. Crit Care Lond Engl. 2007; 11 (3): 216.
19. Dizier S, Forel J-M, Ayzac L, Richard J-C, Hraiech S, Lehingue S, et al. Early Hepatic Dysfunction Is Associated with a Worse Outcome in Patients Presenting with Acute Respiratory Distress Syndrome: A Post-Hoc Analysis of the ACURASYS and PROSEVA Studies. PloS One. 2015; 10 (12): e0144278.
20. Villacres S M, Medar S S, Aydin S I. Acute Kidney Injury in Children With Acute Respiratory Failure. Clin Pediatr (Phila). 2018; 57 (11): 1340-8.
21. Atam V, Singh A S, Yathish B E, Das L. Acute pancreatitis and acute respiratory distress syndrome complicating Plasmodium vivax malaria. J Vector Borne Dis. 2013 June; 50 (2): 151-4.
22. Fox S E, Akmatbekov A, Harbert J L, Li G, Brown J Q, Heide R S V. Pulmonary and Cardiac Pathology in Covid-19: The First Autopsy Series from New Orleans. medRxiv. 2020 Apr. 10; 2020.04.06.20050575.
23. Ciceri F, Beretta L, Scandroglio A M, Colombo S, Landoni G, Ruggeri A, et al. Microvascular COVID-19 lung vessels obstructive thromboinflammatory syndrome (MicroCLOTS): an atypical acute respiratory distress syndrome working hypothesis. Crit Care Resusc J Australas Acad Crit Care Med. 2020 Apr. 15;
24. Tee A, Wong A, Yusuff T, Rao D, Sidhu P. Contrast-enhanced ultrasound (CEUS) of the lung reveals multiple areas of microthrombi in a COVID-19 patient. Intensive Care Med. 2020 May 18;
25. Jung E M, Stroszczynski C, Jung F. Contrast enhanced ultrasonography (CEUS) to detect abdominal microcirculatory disorders in severe cases of COVID-19 infection: First experience. Clin Hemorheol Microcirc. 2020 Apr. 23;
26. Hernández-Fernández F, Sandoval Valencia H, Barbella-Aponte R A, Collado-Jiménez R, Ayo-Martin Ó, Barrena C, et al. Cerebrovascular disease in patients with COVID-19: neuroimaging, histological and clinical description. Brain. 2020 Oct. 1; 143 (10): 3089-103.
27. Xie Y, Wang X, Yang P, Zhang S. COVID-19 Complicated by Acute Pulmonary Embolism. Radiol Cardiothorac Imaging. 2020 Apr. 1; 2 (2): e200067.
28. Gao Y, Li T, Han M, Li X, Wu D, Xu Y, et al. Diagnostic utility of clinical laboratory data determinations for patients with the severe COVID-19. J Med Virol. 2020 Mar. 17;
29. Zhou F, Yu T, Du R, Fan G, Liu Y, Liu Z, et al. Clinical course and risk factors for mortality of adult inpatients with COVID-19 in Wuhan, China: a retrospective cohort study. Lancet Lond Engl. 2020 28; 395 (10229): 1054-62.
30. Tang N, Li D, Wang X, Sun Z. Abnormal coagulation parameters are associated with poor prognosis in patients with novel coronavirus pneumonia. J Thromb Haemost JTH. 2020; 18 (4): 844-7.
31. Danzi G B, Loffi M, Galeazzi G, Gherbesi E. Acute pulmonary embolism and COVID-19 pneumonia: a random association? Eur Heart J. 2020 Mar. 30;
32. Rotzinger D C, Beigelman-Aubry C, von Garnier C, Qanadli S D. Pulmonary embolism in patients with COVID-19: Time to change the paradigm of computed tomography. Thromb Res. 2020 Apr. 11; 190:58-9.
33. Panigada M, Bottino N, Tagliabue P, Grasselli G, Novembrino C, Chantarangkul V, et al. Hypercoagulability of COVID-19 patients in Intensive Care Unit. A Report of Thromboelastography Findings and other Parameters of Hemostasis. J Thromb Haemost JTH. 2020 Apr. 17;
34. Escher R, Breakey N, Lammle B. Severe COVID-19 infection associated with endothelial activation. Thromb Res. 2020 Apr. 15; 190:62.
35. Lippi G, Plebani M, Henry BM. Thrombocytopenia is associated with severe coronavirus disease 2019 (COVID-19) infections: A meta-analysis. Clin Chim Acta Int J Clin Chem. 2020 Mar. 13; 506:145-8.
36. Yang M, Ng M H L, Li CK. Thrombocytopenia in patients with severe acute respiratory syndrome (review). Hematol Amst Neth. 2005 April; 10 (2): 101-5.
37. Yamamoto K, de Waard V, Fearns C, Loskutoff D J. Tissue distribution and regulation of murine von Willebrand factor gene expression in vivo. Blood. 1998 Oct. 15; 92 (8): 2791-801.
38. Arya M, Anvari B, Romo G M, Cruz M A, Dong J-F, Mclntire L V, et al. Ultralarge multimers of von Willebrand factor form spontaneous high-strength bonds with the platelet glycoprotein Ib-IX complex: studies using optical tweezers. Blood. 2002 Jun. 1; 99 (11): 3971-7.
39. Ware L B, Conner E R, Matthay M A. von Willebrand factor antigen is an independent marker of poor outcome in patients with early acute lung injury. Crit Care Med. 2001 December; 29 (12): 2325-31.
40. Ware L B, Eisner M D, Thompson B T, Parsons P E, Matthay M A. Significance of von Willebrand factor in septic and nonseptic patients with acute lung injury. Am J Respir Crit Care Med. 2004 Oct. 1; 170 (7): 766-72.
41. Dong J, Moake J L, Nolasco L, Bernardo A, Arceneaux W, Shrimpton C N, et al. ADAMTS-13 rapidly cleaves newly secreted ultralarge von Willebrand factor multimers on the endothelial surface under flowing conditions. Blood. 2002 Dec. 1; 100 (12): 4033-9.
42. Padilla A, Moake J L, Bernardo A, Ball C, Wang Y, Arya M, et al. P-selectin anchors newly released ultralarge von Willebrand factor multimers to the endothelial cell surface. Blood. 2004 Mar. 15; 103 (6): 2150-6.
43. Huang J, Roth R, Heuser J E, Sadler J E. Integrin alpha (v) beta (3) on human endothelial cells binds von Willebrand factor strings under fluid shear stress. Blood. 2009 Feb. 12; 113 (7): 1589-97.
44. Tremblay D, van Gerwen M, Alsen M, Thibaud S, Kessler A J, Venugopal S, et al. Impact of anticoagulation prior to COVID-19 infection: a propensity score-matched cohort study. Blood. 2020 May 27;
45. Bernardo A, Ball C, Nolasco L, Moake J F, Dong J. Effects of inflammatory cytokines on the release and cleavage of the endothelial cell-derived ultralarge von Willebrand factor multimers under flow. Blood. 2004 Jul. 1; 104 (1): 100-6.
46. Westwood J-P, Langley K, Heelas E, Machin S J, Scully M. Complement and cytokine response in acute Thrombotic Thrombocytopeniaurpura. Br J Haematol. 2014 March; 164 (6): 858-66.
47. Goshua G, Pine A B, Meizlish M L, Chang C—H, Zhang H, Bahel P, et al. Endotheliopathy in COVID-19-associated coagulopathy: evidence from a single-centre, cross-sectional study. Lancet Haematol [Internet]. 2020, 30 Jun. 2020 [cited July 8]; 0 (0). Available from: https://www.thelancet.com/journals/lanhae/article/PIIS2352-3026 (20) 30216-7/abstract
48. Rauch A, Labreuche J, Lassalle F, Goutay J, Caplan M, Charbonnier L, et al. Coagulation biomarkers are independent predictors of increased oxygen requirements in COVID-19. J Thromb Haemost [Internet]. [cited 2020 Aug. 26]; n/a (n/a). Available from: http://onlinelibrary.wiley.com/doi/abs/10.1111/jth.15067
49. Ladikou E E, Sivaloganathan H, Milne K M, Arter W E, Ramasamy R, Saad R, et al. Von Willebrand factor (vWF): marker of endothelial damage and thrombotic risk in COVID-19? Clin Med Lond Engl. 2020 Jul. 21;
50. Helms J, Tacquard C, Severac F, Leonard-Lorant I, Ohana M, Delabranche X, et al. High risk of thrombosis in patients with severe SARS-COV-2 infection: a multicenter prospective cohort study. Intensive Care Med. 2020; 46 (6): 1089-98.
51. Huisman A, Beun R, Sikma M, Westerink J, Kusadasi N. Involvement of ADAMTS13 and von Willebrand factor in thromboembolic events in patients infected with SARS-COV-2. Int J Lab Hematol. 2020 October; 42 (5): e211-2.
52. Mancini I, Baronciani L, Artoni A, Colpani P, Biganzoli M, Cozzi G, et al. The ADAMTS13-von Willebrand factor axis in COVID-19 patients. J Thromb Haemost JTH. 2020 Nov. 23;
53. Philippe A, Chocron R, Gendron N, Bory O, Beauvais A, Peron N, et al. Circulating Von Willebrand factor and high molecular weight multimers as markers of endothelial injury predict COVID-19 in-hospital mortality. Angiogenesis. 2021 Jan. 15; 1-13.
54. Goudot G, Chocron R, Augy J-L, Gendron N, Khider L, Debuc B, et al. Predictive Factor for COVID-19 Worsening: Insights for High-Sensitivity Troponin and D-Dimer and Correlation With Right Ventricular Afterload. Front Med. 2020; 7:586307.
55. Gattinoni L, Coppola S, Cressoni M, Busana M, Rossi S, Chiumello D. Covid-19 Does Not Lead to a “Typical” Acute Respiratory Distress Syndrome. Am J Respir Crit Care Med. 2020 Mar. 30;
56. Lippi G, Wong J, Henry B M. Hypertension and its severity or mortality in Coronavirus Disease 2019 (COVID-19): a pooled analysis. Pol Arch Intern Med. 2020 Mar. 31;
57. de Vries P S, van Herpt T T W, Ligthart S, Hofman A, Ikram M A, van Hoek M, et al. ADAMTS13 activity as a novel risk factor for incident type 2 diabetes mellitus: a population-based cohort study. Diabetologia. 2017; 60 (2): 280-6.
58. Sedaghat S, de Vries P S, Boender J, Sonneveld M A H, Hoorn E J, Hofman A, et al. von Willebrand Factor, ADAMTS13 Activity, and Decline in Kidney Function: A Population-Based Cohort Study. Am J Kidney Dis Off J Natl Kidney Found. 2016 November; 68 (5): 726-32.
59. Sonneveld M A H, Franco O H, Ikram M A, Hofman A, Kavousi M, de Maat M P M, et al. Von Willebrand Factor, ADAMTS13, and the Risk of Mortality: The Rotterdam Study. Arterioscler Thromb Vasc Biol. 2016; 36 (12): 2446-51.
60. Sonneveld M a. H, Kavousi M, Ikram M A, Hofman A, Rueda Ochoa O L, Turecek P L, et al. Low ADAMTS-13 activity and the risk of coronary heart disease—a prospective cohort study: the Rotterdam Study. J Thromb Haemost JTH. 2016; 14 (11): 2114-20.
61. Sonneveld M A H, de Maat M P M, Portegies M L P, Kavousi M, Hofman A, Turecek P L, et al. Low ADAMTS13 activity is associated with an increased risk of ischemic stroke. Blood. 2015 Dec. 17; 126 (25): 2739-46.
62. Bongers T N, de Bruijne E L E, Dippel D W J, de Jong A J, Deckers J W, Poldermans D, et al. Lower levels of ADAMTS13 are associated with cardiovascular disease in young patients. Atherosclerosis. 2009 November; 207 (1): 250-4.
63. Bongers T N, de Maat M P M, van Goor M-L P J, Bhagwanbali V, van Vliet H H D M, Gómez García E B, et al. High von Willebrand factor levels increase the risk of first ischemic stroke: influence of ADAMTS13, inflammation, and genetic variability. Stroke. 2006 November; 37 (11): 2672-7.
64. Bongers T N, Emonts M, de Maat M P M, de Groot R, Lisman T, Hazelzet J A, et al. Reduced ADAMTS13 in children with severe meningococcal sepsis is associated with severity and outcome. Thromb Haemost. 2010 June; 103 (6): 1181-7.
65. Bhogal P, Jensen M, Collins G, Spooner O, Makalanda L, Hart D, et al. Letter in response to: Coagulation markers are independent predictors of increased oxygen requirements and thrombosis in COVID-19. J Thromb Haemost. 2020; 18 (12): 3382-4.
66. Sobel M, McNeill P M, Carlson P L, Kermode J C, Adelman B, Conroy R, et al. Heparin inhibition of von Willebrand factor-dependent platelet function in vitro and in vivo. J Clin Invest. 1991 May; 87 (5): 1787-93.
67. Sobel M, Soler D F, Kermode J C, Harris R B. Localization and characterization of a heparin binding domain peptide of human von Willebrand factor. J Biol Chem. 1992 May 5; 267 (13): 8857-62.
69. van Haren F M P, Page C, Laffey J G, Artigas A, Camprubi-Rimblas M, Nunes Q, et al. Nebulised heparin as a treatment for COVID-19: scientific rationale and a call for randomised evidence. Crit Care Lond Engl. 2020 Jul. 22; 24 (1): 454.
70. Dixon B, Campbell D J, Santamaria J D. Elevated pulmonary dead space and coagulation abnormalities suggest lung microvascular thrombosis in patients undergoing cardiac surgery. Intensive Care Med. 2008 July; 34 (7): 1216-23.
71. Dixon B, Schultz M J, Smith R, Fink J B, Santamaria J D, Campbell D J. Nebulized heparin is associated with fewer days of mechanical ventilation in critically ill patients: a randomized controlled trial. Crit Care Lond Engl. 2010; 14(5): R180.
72. Dixon B, Smith R, Santamaria J D, Orford N R, Wakefield B J, Ives K, et al. A trial of nebulised heparin to limit lung injury following cardiac surgery. Anaesth Intensive Care. 2016 January; 44 (1): 28-33.
73. Dixon B, Schultz M J, Hofstra J J, Campbell D J, Santamaria J D. Nebulized heparin reduces levels of pulmonary coagulation activation in acute lung injury. Crit Care Lond Engl. 2010; 14 (5): 445.
74. Clausen T M, Sandoval D R, Spliid C B, Pihl J, Perrett H R, Painter C D, et al. SARS-COV-2 Infection Depends on Cellular Heparan Sulfate and ACE2. Cell. 2020 Nov. 12; 183 (4): 1043-1057.e15.
75. Liu L, Chopra P, Li X, Bouwman K M, Tompkins S M, Wolfert M A, et al. Heparan sulfate proteoglycans as attachment factor for SARS-COV-2. bioRxiv. 2021 Jan. 4; 2020.05.10.087288.

1. A method of synthesis of medium molecular weight heparin, the method comprising the steps of:
a. dissolving unfractionated heparin in an aqueous buffer solution adjusted to between about pH 5.0 and about pH 9.0 to provide a first solution;
b. adding an oxidising agent to the first solution to provide a second solution; and
C. incubating the second solution at a temperature of from about 0° C. to about 10° C. to form a medium molecular weight heparin solution.

2. The method according to claim 1, wherein the aqueous buffer solution is adjusted to about pH 7.0.

3. The method according to claim 1, wherein the aqueous buffer solution is a phosphate buffer.

4. The method according to claim 3, wherein the phosphate buffer is a sodium phosphate buffer.

5. The method according to claim 1, wherein the incubating step c. is carried out for from about 1 hour to about 48 hours.

6. The method according to claim 1, wherein an incubation temperature is about 4° C.

7. The method according to claim 1, wherein a temperature of the aqueous buffer solution in step a. is about 0° C.

8. The method according to claim 1, wherein the oxidising agent is a periodate, preferably sodium periodate or potassium periodate.

9. The method according to claim 1, wherein the method further comprises
d. inactivating the oxidising agent in the medium molecular weight heparin solution.

10. The method according to claim 9, wherein the oxidising agent is inactivated by the addition of an inactivating agent selected from the group consisting of: D-mannitol, glycerol, N-acetylmethionine, sodium sulfite, and combinations thereof.

11. The method according to claim 9, wherein the oxidising agent is inactivated by the addition of D-mannitol.

12. The method according to claim 10, wherein a molar ratio of the oxidising agent to the inactivating agent is from about 1:1 to about 1:10.

13. The method according to claim 1, wherein the method further comprises:
e. dialysing the medium molecular weight heparin solution in a dialysate to provide a dialysed medium molecular weight heparin sample.

14. The method according to claim 13, wherein in the dialysing step e. the dialysate is water.

15. The method according to claim 13, her wherein the dialysing step e. is carried out in 2 kD cut off tubing.

16. The method according to claim 13, wherein the method further comprises
f. isolating the medium molecular weight heparin from the dialysed heparin sample.

17. The method according to claim 16, wherein the dialysed heparin sample is freeze-dried to isolate the medium molecular weight heparin.

18. The method according to claim 1, wherein the medium molecular weight heparin has an average molecular weight of from greater than about 8000 Da to about 13000 Da.

19. The method according to claim 1, wherein the medium molecular weight heparin has an average molecular weight of about 11000 Da.

20. The method according to claim 1, wherein the medium molecular weight heparin comprises at least three units of a IdoA2S-GlcNS6S disaccharide.

21. The method according to claim 1 wherein the method does not include an alkaline elimination step.

22. The method according to claim 1 wherein the method does not include the addition of an alkali metal salt.

23. The method according to claim 22 wherein the alkali metal salt comprises NaOH, KOH or LiOH.

24. The method according to claim 22 wherein the alkali salt is NaOH, KOH or LiOH.

25. A kit suitable for preparing medium molecular weight heparin, wherein the kit comprises:
a. unfractionated heparin;
b. an aqueous buffer solution adjusted to between about pH 5.0 and about pH 9.0;
c. an oxidising agent; and
d. optionally, an inactivating agent.

26.-75. (canceled)
